(19) United States
(12) Patent Application Publication
(10) Pub. No.: US 2003/0001965 A1
(43) Pub. Date: Jan. 2, 2003

(54) System and method for coordinating communications network advertising material

(75) Inventors: XiWei Cao, Chicago, IL (US); Edwin C. Price, Chicago, IL (US); Mike H. Kim, Naperville, IL (US); John S. Walsh, Chicago, IL (US)

Correspondence Address: FOLEY HOAG LLP, PATENT GROUP, WORLD TRADE CENTER WEST, 155 SEAPORT BOULEVARD, BOSTON, MA, 02110-2600, US

(73) Assignee: Radiowave.Com Inc.

(21) Appl. No.: 10/114,424

(22) Filed: Apr. 1, 2002

Related U.S. Application Data
(63) Continuation of application No. 09/163,288, filed on Sep. 29, 1998, now abandoned.

(51) Int. Cl. H04N 7/173; H04N 9/475

(52) U.S. Cl. 348/515; 348/512; 725/110

(57) ABSTRACT

A system and method of coordinating a visual display with audio advertisements broadcast over a communications network such as the Internet is provided. A run-time procedure in which the visual display is retrieved and concurrently displayed at about the time the audio advertisement is broadcast is described. In addition, a set-up procedure, in which scheduled broadcast times for the audio advertisements are captured and provided for use in scheduling the broadcasts of the corresponding visual displays, is also described. The system and method can be beneficially employed in other environments, such as the case in which a first audio, visual, or audiovisual segment or stream is coordinated with a predetermined second audio, visual, or audiovisual segment or stream, and a selected one of the first and second segments or streams includes or comprises advertising material.

### BACKGROUND OF THE INVENTION

As communications networks such as the Internet have become prevalent as a means of communication in today's society, and desktop and laptop computers have proliferated within the home and office, many have begun to consider the Internet as yet another broadcast medium with which to reach consumers. Indeed, due to the potential for growth of the Internet, many have come to view it as a broadcast medium that rivals in importance traditional media such as radio broadcasting.

As part of this effort, a development is underway by companies such as broadcast.com, www.broadcast.com, to provide broadcasts over the Internet from sources such as radio stations. Further information concerning broadcasting audio information over computer networks is available in “BROADCAST AND DISTRIBUTION SYSTEM AND METHOD,” U.S. patent application Ser. No. 08/961,314, filed Nov. 5, 1996, and “AUDIO CONTENT PLAYER METHODS, SYSTEMS, AND ARTICLES OF MANUFACTURE,” U.S. patent application Ser. No. 08/976,971, filed Nov. 25, 1997, both of which are hereby incorporated by reference herein as though set forth in full.

The efforts of companies such as broadcast.com have yet to tap into the enormous potential of the Internet as an advertising medium. For example, in the case of audio broadcasts over the Internet, audio advertisements are simply broadcast over the Internet with no effort being made to coordinate the audio advertisement with a visual display or other interaction with the user. Consequently, the impact of the audio advertisement is limited, and the opportunity to generate a targeted response, such as an impulse purchase, through a coordinated audio-visual display is wasted. The end result is lost advertising revenue as advertisers are unwilling to pay significant additional money simply for broadcasts of audio advertisements over the Internet.

At the same time, the difficulty of coordinating and integrating visual displays with advertisements over the Internet is compounded by the lack of an integrated broadcast scheduler for visual and related audio advertisements. Although broadcast schedulers are available for handling audio broadcasts, such as that from Marketron, Inc. of Ketchum, Id., and other schedulers are available for handling on-line visual or banner advertisements, such as that from NetGravity, Washington, D.C., no one system is available for handling both audio and visual advertising broadcasts over the Internet. The cost of entering redundant data into two different systems and the risk that the schedules maintained by the two systems may become unsynchronized provides a significant deterrent to any attempt to coordinate visual and audio advertisements over the Internet.

Accordingly, it is an object of the subject invention to provide a means for coordinating broadcasts of visual displays or advertisements with broadcasts of related audio advertisements over a communications network such as the Internet.

An additional object is a means for enabling the coordination of broadcasts of visual displays or advertisements with broadcasts of related audio advertisements.

Another object is a means to increase the impact of audio advertisements broadcast over communications networks such as the Internet.

A further object is an integrated system for scheduling and coordinating broadcasts of visual and audio advertisements over a communications network such as the Internet.

A further object is an interface between a preexisting system for managing broadcasts of audio advertisements with a preexisting system for managing on-line displays over a communications network of visual or banner advertisements.

Another object is a means to allow the use of preexisting systems for scheduling broadcasts of audio advertisements to also perform scheduling of broadcasts of visual advertisements over communications networks such as the Internet.

Further objects include utilization or achievement of the foregoing objects, alone or in combination. Additional objects and advantages are set forth in the description, which follows, or will be apparent to those of ordinary skill in the art who practice the invention.

### SUMMARY OF THE INVENTION

In accordance with the principles of the subject invention as described herein, there is provided a system and method of coordinating a visual display with audio advertisements broadcast over a communications network, whether wired or wireless, analog or digital and whether utilizing circuit, packet, or other communications technologies. In one example, the network is the Internet. A run-time system and procedure is provided in which the visual display is retrieved and concurrently displayed at about the time the audio advertisement is broadcast. In addition, a set-up system and procedure is also provided, in which at least one interface is provided between a first system for managing displays of visual or banner advertisements over a communications network, and a second system for managing broadcasts of audio advertisements over the network. In one embodiment of the at least one interface, scheduling information and the like maintained by the second system is automatically provided to the first system, thusly enabling the run-time system and procedure.

According to one aspect of the invention, there is provided a system for coordinating a visual display with an audio broadcast over a communications network comprising: a client in the communications network for accessing a player configured to (1) receive over the communications network data representative of a plurality of audio segments; (2) detect and play an audio segment which includes advertising material; and (3) display generally concurrently with the playing of the segment an image related to the advertising material; at least one server in the network accessible by the player and a first system executable on the at least one server configured to (1) maintain information related to the advertising material, including a schedule for the advertising material, and data representative of the image relating to the advertising material; and (2) manage display of the image consistently with the schedule for the advertising material; and at least one interface between a second system, executable on one or more machines for managing broadcasts of audio advertisements, and the first system, the at least one interface executable on one or more machines for providing to the first system the information related to the advertising material derived at least in part from data maintained by the second system.

According to another aspect of the invention, there is provided a system for enabling coordination of a visual display with an audio broadcast over a communications network comprising: at least one server in the network and a first system executable on the at least one server configured to (1) store information related to advertising material, including a schedule for the advertising material, and data representative of an image relating to the advertising material; and (2) manage display of the image in accordance with the schedule; and at least one interface between a second system, executable on one or more machines for managing displays of advertisements on the communications network, and the first system, the at least one interface executable on one or more machines for providing to the first system the information related to the advertising material derived at least in part from data maintained by the second system.

The systems and methods can be beneficially employed in other environments and contexts, such as the case in which a first audio, visual, or audiovisual segment or stream which is or includes an advertisement is desired to be coordinated with an a second audio, visual or audiovisual segment or stream which is not and does not include an advertisement, or the case in which a first audio, visual, or audiovisual segment or stream which is not and does not include an advertisement is desired to be coordinated with a second audio, visual, or audiovisual segment or stream which is or includes an advertisement.

Related methods and computer readable media are also provided.

### BRIEF DESCRIPTION OF THE DRAWINGS

FIG. 1 is an illustration of an example environment of the subject invention.

FIG. 2 is an illustration of exemplary embodiments of tables used to coordinate visual displays with audio broadcasts in the environment of FIG. 1.

FIG. 3 is an exemplary screen display provided by the player in the example environment of FIG. 1.

FIG. 4 is an exemplary embodiment of a table used to coordinate visual displays with audio broadcasts of advertisements over a communications network in accordance with the subject invention.

FIG. 5 is an illustration of a run-time system and a set-up system for coordinating visual displays with audio broadcasts of advertisements over a communications network in accordance with the subject invention.

FIG. 6 is an exemplary embodiment of a screen display provided during set-up processing to support the coordination of visual displays with audio broadcasts over a communications network in accordance with the subject invention.

FIG. 7 is a flowchart depicting an embodiment of the run-time process of the subject invention.

FIG. 8 is a flowchart depicting an embodiment of the set-up process of the subject invention.

FIG. 9 is an exemplary embodiment of a screen display providing a user with a menu of options during set-up processing.

FIG. 10 is an exemplary embodiment of a screen display providing a user to search for records for a particular contract.

FIG. 11 is an exemplary embodiment of a screen display illustrating a modify option in which a user elects to modify a record for a particular spot.

FIG. 12 is an exemplary embodiment of a screen display illustrating an add option in which a user elects to add a record for a spot.

FIG. 13 is an exemplary embodiment of a screen display illustrating a delete option in which a user elects to delete a record for a particular spot.

FIGS. 14 and 15 are exemplary embodiments of screen displays illustrating the create option in which a user elects to add a record for a spot in the absence of an entry for a corresponding contract.

FIGS. 16a and 16b illustrate examples of tables 37a and 37b in one exemplary implementation.

FIGS. 17a and 17b illustrate an example of code resident on continuity workstation 35a for invoking functions of API 44 in one implementation.

FIGS. 18a-18f illustrate an example of code, which embodies the front-end of API 44 in one implementation.

FIGS. 19a-19e illustrate an example of a table of functions performed by the back-end of API 44 in one implementation.

FIG. 20 illustrates NetGravity tables in one implementation.

FIG. 21 is a listing of the routine ng_ads.asp in one implementation of the back-end of API 44.

FIGS. 22a-22f comprise a listing of the routine ng_ads.js in the one implementation of the back-end of API 44.

FIG. 23 is a listing of the routine ng_advertisers.asp in one implementation of the back-end of API 44.

FIGS. 24a-24c comprise a listing of the routine ng_advertisers.js in one implementation of the back-end of API 44.

FIG. 25 is a listing of the routine ng_dimensions.asp in one implementation of the back-end of API 44.

FIGS. 26a-26c comprise a listing of the routine ng_dimensions.js in one implementation of the back-end of API 44.

FIG. 27 is a listing of the routine ng_families.asp in one implementation of the back-end of API 44.

FIGS. 28a-28b comprise a listing of the routine ng_families.js in one implementation of the back-end of API 44.

FIG. 29 is a listing of the routine ng_familytargets.asp in one implementation of the back-end of API 44.

FIGS. 30a-30b comprise a listing of the routine ng_familytargets.js in one implementation of the back-end of API 44.

FIG. 31 is a listing of the routine ng_profiles.asp in one implementation of the back-end of API 44.

FIGS. 32a-32d comprise a listing of the routine ng_profiles.js in one implementation of the back-end of API 44.

FIG. 33 is a listing of the routine ng_properties.asp in one implementation of the back-end of API 44.

FIGS. 34a-34c comprise a listing of the routine ng_properties.js in one implementation of the back-end of API 44.

FIG. 35 is a listing of the routine ng_runs.asp in one implementation of the back-end of API 44.

FIGS. 36a-36d comprise a listing of the routine ng_runs.js in one implementation of the back-end of API 44.

FIG. 37 is a listing of the routine ng_targets.asp in one implementation of the back-end of API 44.

FIGS. 38a-38b comprise a listing of the routine ng_targets.js in one implementation of the back-end of API 44.

FIG. 39 is a listing of the routine ng_values.asp in one implementation of the back-end of API 44.

FIGS. 40a-40d comprise a listing of the routine ng_values.js in one implementation of the back-end of API 44.

### DESCRIPTION OF THE PREFERRED EMBODIMENTS

### 1. EXAMPLE ENVIRONMENT OF THE SUBJECT INVENTION

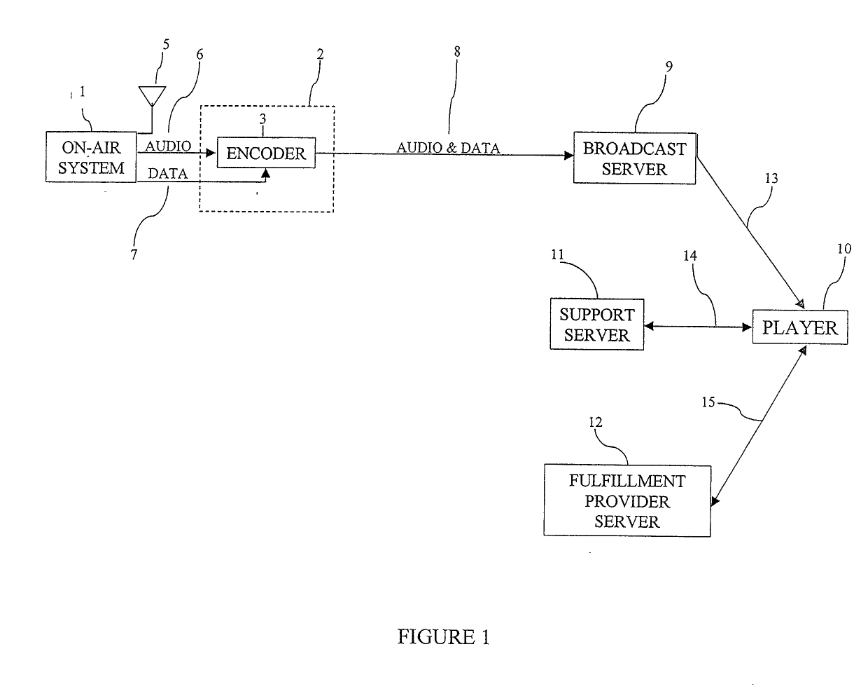

An example environment in which the subject invention may be beneficially employed is illustrated in FIG. 1. Preferably, this environment is an example of the inventions described in “SYSTEM AND METHOD FOR COORDINATING SUPPLEMENTAL MATERIALS WITH BROADCAST MATERIAL,” Lyon & Lyon Dkt. No. 237/092, “SYSTEM AND METHOD FOR PROVIDING BROADCAST MATERIAL HISTORY,” Lyon & Lyon Dkt. No. 237/093, and “SYSTEM AND METHOD FOR PLAYING SUPPLEMENTAL MATERIALS WITH BROADCAST MATERIAL,” Lyon & Lyon Dkt. No. 237/172, each of which is owned by the assignee of the subject application, and each of which is filed on even date herewith. Each of these applications is incorporated by reference herein as though set forth in full. This description is provided by way of example only solely to illustrate the context in which the subject invention may be beneficially employed, and should not be continued as limiting.

As illustrated, in this environment, on-air system 1 of the type typically employed by a broadcaster such as a radio station or the like broadcasts a predetermined audio stream comprising a predetermined sequence of songs interspersed with one or more audio advertisements. In one example, the on-air system is a commercially available system such as ENCO or Prophet commonly used by radio stations and the like. The on-air system transmits this audio information over the airwaves through antenna 5, and also provides it in digital form over signal line 6 to encoder 3. Concurrently, the on-air system also provides over signal line 7 data in the form of identifying indicia or codes such as cut codes. The codes are indicators of the audio information concurrently being transmitted over signal line 6. Advantageously, each song or advertisement comprising the audio information being concurrently transmitted over signal line 6 comprises a distinct segment. A cut code or cut number corresponding to and uniquely identifying a segment from the standpoint of the radio station is transmitted over signal line 7 concurrently with the transmission of the corresponding segment over signal line 6. (For purposes of this disclosure, the phrases “cut code” and “cut number” or “cut #” will be used synonymously).

Encoder 3 is configured to compress the audio information received over signal line 6. Advantageously, the encoder can be implemented using a commercially available encoding scheme such as, for example, the “Active Streaming Format” from Microsoft Netshow, or the “SureStream” G2 encoding scheme from Real. Advantageously, the encoder 3 is part of a coordinating encoder 2 configured to merge the cut codes provided over signal line 7 with the audio information provided over signal line 6 to provide a merged data stream over signal line 8. The encoder 3 under the control of the coordinating encoder 2 performs this merging procedure. Advantageously, in this procedure, a cut code is inserted into the merged stream throughout the audio segment it identifies. In one embodiment, Radowave.com, the assignee of the subject application, provides the coordinating encoder 2.

The audio information transmitted from antenna 5 is advantageously received by one or more traditional RF receivers (not shown) configured in the form of radios and the like. This process is known to those of ordinary skill in the art, and need not be described further.

Meanwhile, the merged stream is provided over signal line 8 to one or more broadcast servers 9. In one variant, the transmission of the merged data to the broadcast servers is accomplished through a wireless interface rather than a signal line. Advantageously, in one embodiment, the servers are provided by broadcast.com, of Dallas, Tex., www.broadcast.com, and are configured to simply broadcast the merged stream over a communications network such as the Internet.

A player 10 is provided which executes on a client computer or other end use device within the communications network. Alternatively, the player is a web-based player resident on a server in the network, but accessible through the client machine. The player is configured to receive the merged stream over signal line 13 and play the audio component thereof through speakers or the like (not shown) configured as part of the client computer/end user device. In addition, the player is advantageously associated with the radio station or other broadcaster associated with on-air system 1, such that the identity of the radio station or other broadcaster is known to the player.

The player is also configured to detect the presence of a cut code in the merged stream, and responsive to detecting the presence of a cut code identifying a song, signal another server on the network identified with numeral 11. (The response of the player to detecting the presence of a cut code identifying an advertisement is detailed in the next section). In one embodiment, upon detecting a cut code identifying a song, the player is configured to provide server 11 with the identity of radio station 1, as well as the cut code that has been detected.

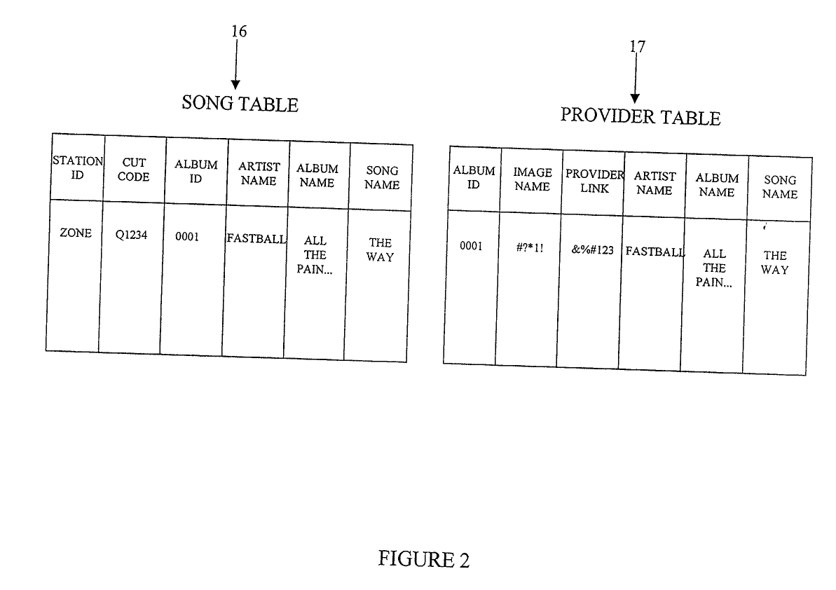

Advantageously, in one embodiment, server 11 is provided by RadioWave.com, the assignee of the subject application, and is configured in accordance with the invention described in the concurrently filed Lyon & Lyon Dkt. Nos. 237/092, 237/093, and 237/172, previously incorporated herein by reference. Responsive to the receipt of a station ID and a cut code identifying a song, the server 11 accesses one or more tables. With reference to FIG. 2, the server 11 first accesses a song table 16, the entries of which correlate a station ID and cut code with an ID of the album containing the song, the name of the artist, the album name, and the song name. Through this step, the server 11 obtains the album ID for the album containing the song associated with the cut code and station ID that was previously sent to the server.

Next, the server 11 accesses a provider table 17. As can be seen, the entries of this table correlate the album ID with (1) a name of an image related to the cut or segment, such as but not limited to an image of the cover of the album or tape containing the song; (2) a provider link, i.e., a URL or other link to additional information related to the song or album, such as a link to a server 12 of a fulfillment provider; (3) the artist name; (4) album name; and (5) song name. In one example, by accessing this table, the server 11 obtains the name of an image file of the album or tape cover containing the song, the artist name, the album name, the song name, and the record label. In one implementation, the fulfillment provider server is that of Amazon, Inc. at www.amazon.com, and the link to this server is a URL link known as an ASIN#. In one embodiment, server 11 obtains the actual image for the album cover, which is either stored locally or on another server accessible from server 11, and then provides the image, song name, artist name, and album name to player 10. In another embodiment, server 11 provides the player 10 with a link to the image stored on another server, and, responsive to this information, the player 10 obtains the actual image for the album cover, or other related image, from fulfillment provider server 12.

In the event that there is not an entry in the provider table 17 for the album ID obtained from the song table 16, the artist name, album name, and song name are obtained from the song table 16. That is the reason why entries for this information are redundantly provided in both the song table 16 and provider table 17. In this event, song name, artist name, and album name are provided to the player 10, but the provider link is omitted.

Responsive to the receipt of the artist name, album name, song name, image, and provider link (this last item of information being provided only in the case in which there is an entry for the album in the provider table) are then provided to the player 10. Upon receiving this information, the player displays it through a suitable display.

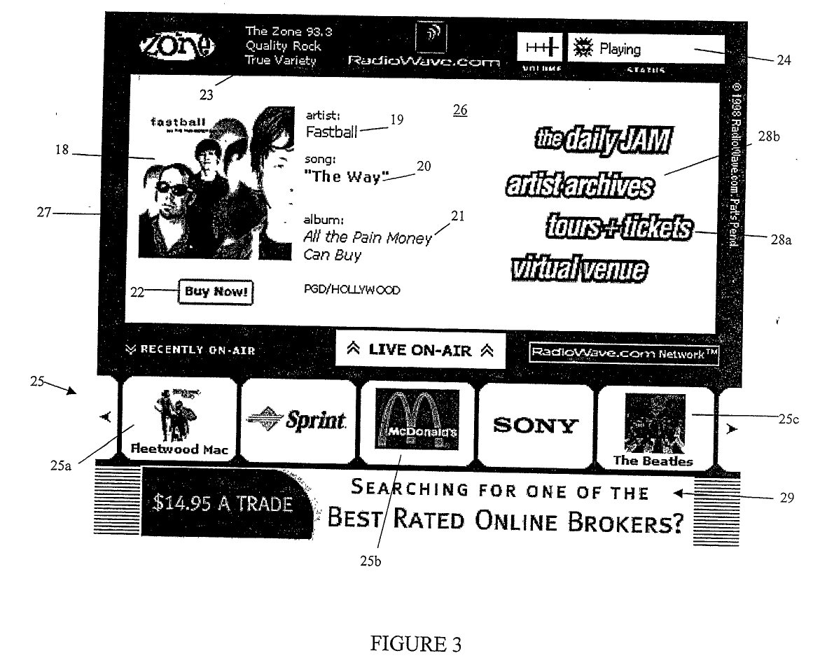

With reference to FIG. 3, an example of such a display is illustrated. As can be seen, the display includes a web-based component 26 in which is displayed the image 18 of the album cover for the song that is currently being played, the name 19 of the artist of the song, the name 20 of the song, and the name 21 of the album in which the song is contained. In addition, around the web-based display component is a border 27, which is advantageously stored locally on the client machine. Displayed within or at the border 27 is an identifier 23 for the radio station 1 from which the audio information being broadcast originates, and an indicator 24 of the quality of the signal, and the elapsed listening time.

In one embodiment, a history component 25 is displayed below the web-based component. This component contains information about the audio segments that have been played by the player in the recent past. In the illustrated embodiment, the history information is displayed with the most recent information beginning at the left, and the less recent information being arranged towards the right. As can be seen, the information is displayed is the image associated with the segment. Also, images can be displayed both for songs and advertisements that have aired. Starting from the left, it can be seen that an image 25a from a Fleetwood Mac album cover is displayed, indicating that a song from this album was most recently played. This is followed by images for advertisements, which have aired, from Sprint, McDonalds, and Sony. The image for the McDonalds advertisement is identified with numeral 25b. Next, image 25c for a Beatles album cover is displayed, indicating that a song from this album was played. As audio information is played, this history information is updated.

A “buy now” button 22 is also displayed. When a user clicks on this button 22, with reference to FIG. 1, a link is established to a program resident on fulfillment provider server 12 using the provider link provided by the server 11. As discussed, in one example, the fulfillment provider server 12 is www.amazon.com, and the provider link is an ASIN# which is a URL link to this server. Once this link is established, in one embodiment, a browser is launched allowing a user to peruse information resident on server 11 and purchase the album containing the song being played or related albums. Alternatively, the user is allowed access to this information through a feature window displayed by the player. In one example, the link to server 12 is established simply by appending the provider link to the URL of the server 12. In this example, it is assumed that the URL of the server 12 is known to the player 10, but it should be appreciated that examples are possible in which this URL information is provided to player 10 by server 11.

It should be appreciated that examples are possible in which server 11 provides other links associated with the song being played to the player 10. One such example is a URL or other link to information describing the concert tour schedule of the artist of the song being aired, and a program allowing the user to purchase tickets to one of these concerts. With reference to FIG. 3, when a user clicks on a “tours and tickets” identifier 28a, the link to this information can be established, and a browser launched or other mechanism such as a feature window initiated allowing the user to peruse this information. Another example is a URL or other link to information describing other albums by the artist of the song currently being played. Again with reference to FIG. 3, when a user clicks on an “artist archives” identifier 28b, the link to this information can be established, and a browser launched or other mechanism initiated, such as a feature window, allowing the user to peruse this information. A third example is a URL or other link to information about a product or service being advertised. According to this example, an advertisement regarding a product or service is displayed within web-based component 26. When a user clicks on this information, a URL or other link can be established to a server configured to provide additional information about this product or service, and a browser launched or other mechanism initiated, such as a feature window, to allow a user to peruse this information.

The above is provided by way of example only, and it should be appreciated that other environments are possible allowing beneficial employment of the subject invention, including the more generic examples described in the foregoing Lyon & Lyon Dkt. Nos. 237/092, 237/093, and 237/172, filed on even date herewith, and previously incorporated by reference herein as though set forth in full.

2. Embodiments of the Subject Invention

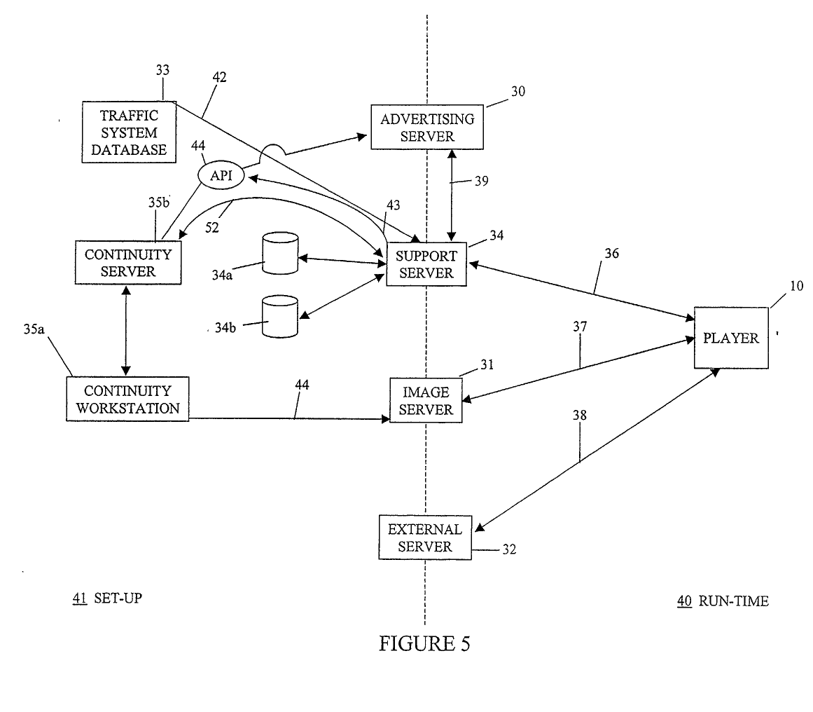

With reference to FIG. 5, the process of coordinating visual displays with audio advertisements broadcast over the Internet can include both a run-time component 40, and a set-up component 41. The run-time component of this process will first be described, followed by the set-up component 41 of this process.

With reference to FIG. 1, the player 10 receives over signal line 13 a merged stream of audio data and digital data in which the audio data comprises audio segments, such as songs or advertisements, and the digital data comprises cut codes and the like uniquely identifying each segment from the standpoint of the radio station or other broadcaster associated with on-air system 1. Advantageously, a cut code is inserted in the stream throughout the audio segment it identifies. However, embodiments are possible in which the cut codes bear other known relationship to the segments they identify. The subject invention includes means to coordinate visual displays or advertisements with broadcast content being played over the player 10, such as is described in the foregoing example environment.

With reference to FIG. 5, in which, compared to FIG. 1, like elements are referenced with like identifying numerals, when a cut code identifying an audio advertisement is detected by player 10, an access is made to a server 34 over signal line 36. Advantageously, the cut code and station ID are both provided to the server 34. In one embodiment, the server 34 is distinct from the servers 11 and 12 depicted in FIG. 1, but it should be appreciated that embodiments are possible in which each of these servers are combined into one or more physical servers.

Responsive to the receipt of this information, with reference to FIG. 5, server 34 accesses advertising server 30 on which is resident data correlating the cut code and station ID to a contract # or contract ID identifying the contract between an advertiser and the radio station or other broadcaster. (For purposes of this disclosure, the phrases “contract #,” “contract ID” and “contract number” will be used synonymously). In one embodiment, this contract can govern information such as, for example, the advertisement at hand, the name of the advertiser, the product or service being advertised, the “flight” dates for the advertisement, i.e., the dates over which the advertisement is scheduled to run, the image name, i.e., the name of an image, such as a gif image, to be displayed at or about the same time the corresponding audio advertisement is run, and the redirect link, i.e., a URL or other link to a server from which the user can obtain additional information about the product or service being advertised if desired. In one embodiment, this data is maintained by a system, such that that provided by NetGravity, Inc., of Washington, D.C., www.netgravity.com, for managing on-line visual or banner advertisements. In this example, this system executes on server 30.

Server 30 then compares the current date with the scheduled flight dates to ensure it is within the range of the scheduled flight dates for the advertisement. If so, the server 30 then initiates a series of operations such that the image is displayed by the player at about the same time the related audio advertisement segment, i.e., the audio segment in the merged stream that corresponds to the cut code, is being broadcast. If not, the server 30 refrains from initiating this series of operations, it being assumed that the contract calls for the advertisement to be played in audio form only without a corresponding visual display or that the time called for coordinating a visual display with the audio advertisement has expired.

Assuming that the current date is-within the scheduled flight dates, in one embodiment, the server 30 then arranges to have provided to the player 10 a link to the actual image for the visual display as well as the redirect link, and the player 10 then retrieves the actual image from image server 31 over signal line 37. Optionally, server 30 arranges to have other information provided to the player, such as the name of the advertiser, and the name of the product or service being advertised. In one embodiment, additional information can be provided, such as an image of a coupon or the like indicating a discount or other promotion being offered by the advertiser, or forms to be filled out by a user, e.g., registration or subscription forms, etc.

In one embodiment, a cut code in the audio stream alerts the player 10 that an advertisement is about to be played. Player 10 contacts the support server 34 and support server 34 provides the cut code and station ID to advertisement server 30, on which is stored tables correlating the cut code and station ID to a URL or other link to the image, and the redirect URL or other link to additional information related to the advertisement. In one embodiment, the advertisement server 30 looks up the cut code and station ID in these tables and returns an html page to the support server 34 in which is embedded an image URL. Support server 34 relays the html page, including the image URL, to player 10, which parses the html page and extracts the image URL. Player 10 locates the image URL on image server 31 and requests the image. Image server 31 returns the image to player 10, which is then stored locally on the client computer terminal accessing or executing the player. In this embodiment, the advertisement server 30 also looks up a redirect URL or other link to additional information related to the advertisement using the station ID and cut code, and provides this to the player.

Responsive to the receipt of this information, the player 10 then displays some or all of this information at the same time as the corresponding audio advertisement is being played. With reference to FIG. 3, in one embodiment, the image for the advertisement is displayed within the web page portion 26 of the visual display. Optionally, the name of the advertiser, the product or service being advertised, and other related information can also be displayed. In another embodiment, this information is displayed within portion 29 of the visual display.

With reference to FIG. 5, if the user clicks on the image for the advertisement, a link is established over signal line 38 to a server 32 on which is resident additional information about the product or service being advertised. In one embodiment, this link is established using the redirect URL or other link provided to the player. Once the link is established, a browser is spawned or other mechanism initiated, such as a feature window in area 26, allowing the user to peruse this information.

Optionally, a coupon or discount or price quote for the advertiser can also be displayed. With reference to FIG. 5, a coupon can be implemented through suitable entries in the tables maintained by advertisement server 30. When a cut code for the advertisement is detected, a link to an image for the coupon resident either on server 34 or image server 31 or even external server 32 would be provided to player 10 for display in a manner similar to that already described in relation to the image for the advertisement itself. Optionally, the player is configured to allow the coupon to be printed. Also, forms can be displayed which the user can fill out.

The set-up portion of this process and system will now be described. As is known, radio stations employ an individual known as the Continuity Director whose job it is to ensure that advertisements are broadcast at the scheduled dates called for in the contract with the advertiser, that the appropriate advertising copy is broadcast, and that the advertiser is appropriately billed for these services. To manage this process for audio broadcasts, the Continuity Director typically uses one of the available traffic systems provided by companies such as Marketron, Inc., of Ketchum, Id., or Custom Business Systems, Inc. (CBSI) of Reedsport, Oreg. (Additional information about the Marketron system, Marketron's Traffic and Accounting System, is available at www.marketron.com). Upon entering into a contract with an advertiser, the Continuity Director arranges to have information about the contract entered into the system. Typically, this includes information such as the contract number, the name of the advertiser, the name of the product or service being advertised, and the flight dates for the advertisement. This information is then used to manage the audio broadcasts of the advertisement, i.e., to ensure that they are broadcast at the scheduled dates, that the appropriate advertising copy is used, and that the advertiser is appropriately billed for these services.

The subject invention provides a means to utilize this information for the purpose of coordinating visual displays with the audio advertisement broadcasts without requiring an additional manual entry of this information into an additional system, such as the system provided by NetGravity, Inc., of Washington, D.C., for managing on-line banner advertisements. (Additional information about the NetGravity system is available at www.netgravity.com). The means for achieving this objective is part of the subject invention and comprises the set-up process and system 41 illustrated in FIG. 5.

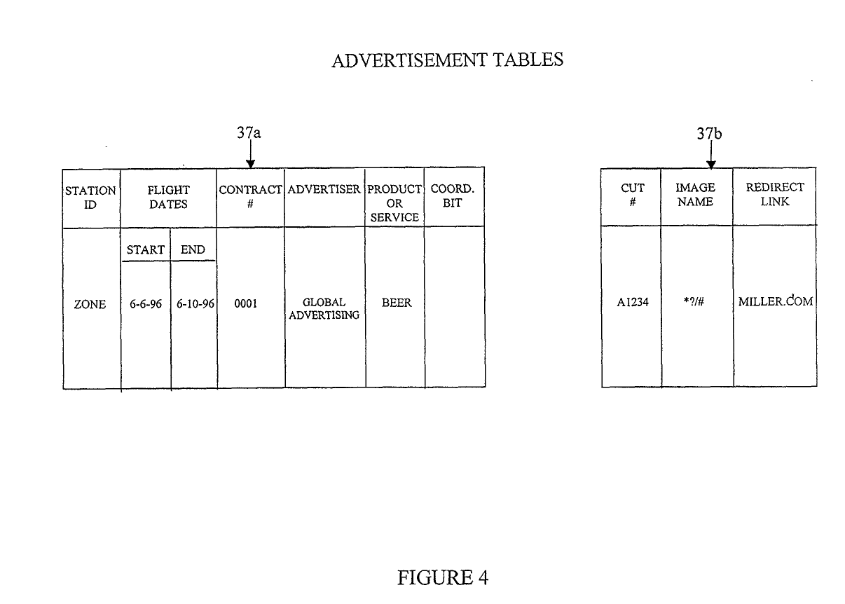

With reference to FIG. 5, the set-up process begins as the scheduling data and the like referred to above for an audio advertisement is entered into traffic system database 33. In one example, this data entry is performed through the Marketron system, but it should be appreciated that embodiments are possible in which other systems such as CBSI are used for this purpose. In one example, the system is embodied in the form of a series of software instructions executable on one or more machines such as a computer. For purposes of this disclosure, a computer can include any processor capable of executing a series of instructions stored in a computer readable memory or storage device. Periodically, the contents of this database can be downloaded over signal line 42 to support server 34. In one embodiment, this downloading is performed nightly through the File Transfer Protocol (FTP), but it should be appreciated that other levels of periodicity and other transfer protocols are possible. Advantageously, this data is stored by the support server 34 in a local database 34a in the form of table 37a in FIG. 4 (although at this point, for each newly added record, in the case of the Marketron system, only the information regarding contract #, flight dates, advertiser, and product or service is available).

A continuity interface can be employed to augment this information. In one example, the continuity interface is embodied in the form of a web-based application in which the interface is resident on a server integrated into the network and accessible from the client machine. According to this example, in the embodiment illustrated in FIG. 5, the continuity interface is embodied in the form of computer software which executes on continuity server 35b, and which interacts with the user through continuity workstation 35a. Appropriate screen displays and the like are displayed on the continuity workstation 35a to allow interaction with the user. In another example, the software is executable on a client machine integrated into the communications network. In yet another embodiment, the software is executable on a standalone machine that is capable of interacting with other machines through hard-wired or wireless links.

In one embodiment, contract ID's and product or service names from the traffic system database 33, which have been stored in table 37a residing on support server 34, are first provided to the continuity server 35b on which the continuity interface is executing, and displayed on continuity workstation 35a. In one implementation, only the records from table 37a in which the Coordinate Bit is cleared, i.e., is a logical “0,” are made available to the continuity server 35b. These records represent advertisements that have not yet been coordinated with visual information. In this implementation, advertisements which have already been coordinated with visual information have their corresponding Coordinate Bits set to a logical “1.” The user then selects from this group one or more contract IDs corresponding to audio advertisements for which the advertiser has purchased coordinated visuals. When the contract IDs have been selected, the corresponding information from table 37a is displayed for each such contract ID.

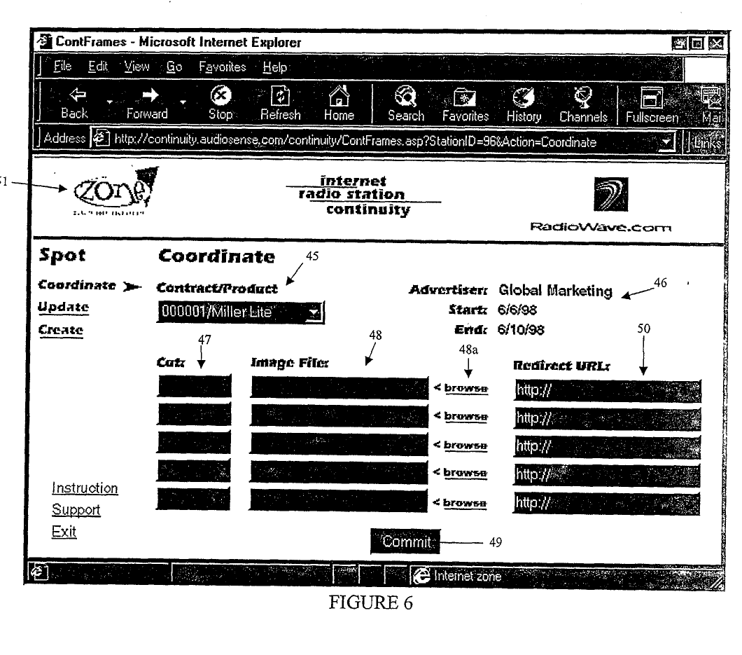

With reference to FIG. 6, an example of such a display is illustrated. Advantageously, a record for each selected advertising contract is downloaded from traffic system database 33 to support server 34, and a screen of the type shown in FIG. 6 is displayed on continuity workstation 35a for each selected advertising contract. In one embodiment, the record for each contract comprises the contract #, product or service name, advertiser name, and scheduled flight dates. With reference to FIG. 6, for each such screen, the contract # and product or service being advertised is displayed. Such is indicated by identifying numeral 45 in FIG. 6. Advantageously, a browser feature 48a allows the user to locate the name of the image file from a file system (not shown in FIG. 5) accessible from continuity workstation 35a. In addition, the name of the advertiser and the flight dates are also displayed. Such is indicated by numeral 46 in FIG. 6. Also, in one embodiment, the station logo for the radio station or other broadcaster involved, which is known to the continuity interface software, is displayed on the screen as well. Such is indicated by numeral 51 in FIG. 6.

A series of prompts or blank spaces is then provided for the purpose of augmenting the information provided from traffic system database 33 for each record. One such prompt solicits input of the cut number inserted into the merged audio stream for the advertisement. Such is identified by numeral 47 in FIG. 6. Another solicits input of the name of the image file comprising the visual display to be coordinated with the broadcast of the audio advertisement. Such is indicated by numeral 48 in FIG. 6. A third such prompt solicits input of the redirect URL or other link for linking the user with additional information about the product or service being advertised. Such is indicated by numeral 50 in FIG. 6.

The user then manually inputs this information. Advantageously, as indicated by FIG. 6, in the case in which there is more than one cut or spot called for by a contract, the user is provided with an opportunity to input the data for such cut. (For purposes of this disclosure, the term “spot” is used synonymously with “cut” and refers to a particular embodiment of an advertisement for a product or service). Once the data has been entered for a contract, the commit button 49 is clicked, indicating that the information that has been input should be used to update the appropriate tables in servers 34 and 30. The newly entered data is routed from continuity server 35b to support server 34 over signal line 52. The data is then stored on database 34b (shown in FIG. 5) in the form of table 37b illustrated in FIG. 4. In one implementation, the data in tables 37a and 37b are correlated to each other through an additional field (not shown in FIG. 4), created to correlate corresponding entries in these tables. According to this implementation, tables 37a and 37b each have an additional column for storage of this field. Using this field, records from table 37a can be associated with corresponding records in table 37b, and vice-versa.

Responsive to the clicking on the commit button, with reference to FIG. 5, the continuity interface software then uploads over signal line 44 the image file to server 31 from continuity workstation 35a on which the image has been previously stored. In addition, in response to a user clicking on the commit button, the continuity server 35b provides advertising server 30 with all instructions and data necessary to schedule and format the display of an advertisement. This is accomplished through an application programming interface (API) 44 that permits the continuity server 35b to communicate with the advertising server 30 in a programmatic manner, and that effects the transfer to advertising server 30 of data from tables 37a and 37b resident on support server 34. In one embodiment, the information sent to advertising server 30 includes, for each spot or cut code, the station ID of the radio station involved, the cut code, the address of the image file on the image server 31, the advertiser name, the contract ID, the product or service name, the flight dates, and the redirect URL or other link for directing the user to additional information about the product or service being advertised. In one implementation, this information is retrieved from tables 37a and 37b, and provided to API 44 over signal line 43. This data is then inserted by API 44 into suitable tables resident on advertising server 30. In one example, these tables are maintained by a system configured to manage on-line visual or banner advertisements over the communications network, such as that provided by NetGravity, Inc., of Washington, D.C., www.netgravitv.com. This information is then available to player 10 to support or enable the run-time process described previously. In this embodiment, the actual file image itself is downloaded to a separate server, image server 31. However, it should be appreciated that embodiments are possible in which the actual image file is downloaded to server 34.

The foregoing process is then repeated for each contract record downloaded from database 33 to server 34 that has been selected by the user for coordination as described previously. When all the tables have been assembled in the manner described, the set-up process is then completed, at least for the period in question, and the run-time process described previously fully enabled. In this manner, significant redundant manual entry of this information is avoided. For example, it can be seen that the contract #, product or service name, advertiser name, and scheduled flight times are only manually input once—during the invocation of the software used to update database 33, such as the Marketron Traffic and Accounting software discussed previously. In addition, it can further be seen that the cut code, image name, and redirect URL or other link for each spot or cut is also manually input only once in the process—during the invocation of continuity interface 35 through continuity workstation 35a. Although embodiments are possible in which some redundant data entry is allowed, it can be seen that the objective of avoiding substantial duplicate and redundant data entry is accomplished. In addition, it can be seen that the very same scheduling information used to schedule broadcasts of audio advertisements, in the form of flight dates and the like, is used also to schedule the visual displays which accompany and are coordinated with the broadcasts of the audio information. Thus, the risk of unsynchronized schedules is avoided.

In the foregoing embodiment, the traffic system database 33 is duplicated at least in part in the support server through the FTP transfer described, and the continuity interface is configured to interact with and utilize the duplicated data resident on support server 34. However, it should be appreciated that embodiments are possible in which the continuity interface interacts directly with the traffic system database 33. In such embodiments, some customization of the continuity interface would be required to support the traffic systems of different vendors. Moreover, such embodiments may not be possible for use with traffic systems of vendors, such as Marketron, which do not currently support direct automated access. However, for vendors that support it, direct automated access would avoid the need to duplicate the traffic system database 33.

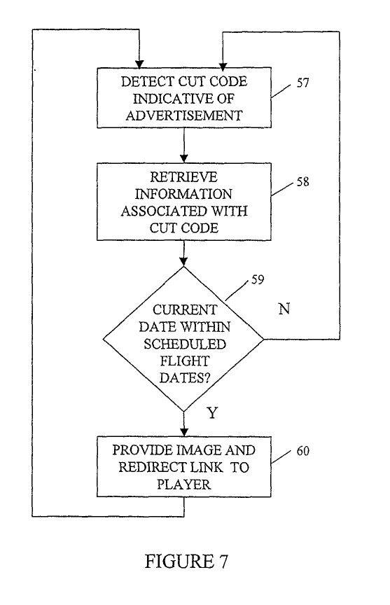

A method of operation of the run-time portion of FIG. 5 according to one embodiment is illustrated in FIG. 7. According to this method, a process of coordinating in real time a visual display with a corresponding audio advertisement broadcast is provided. With reference to FIG. 7, in accordance with this method, in step 57, a cut code indicative of an advertisement is detected by player 10. In step 58, information associated with this cut code, including an identifier of an image (or the image itself), a redirect link, and scheduled flight dates, is retrieved from one or more servers. (If there is no information associated with this cut code, it is assumed to be an uncoordinated advertisement, that is, an advertisement which is intended to be broadcast in audio form only, without any coordination of visual display therewith). In step 59, the current date is compared with the scheduled flight dates to confirm that it is within those dates. If so, a branch is made to step 60; if not, a jump is made back to step 57. In step 60, the image and redirect link are provided to the player 10. Although not shown expressly in FIG. 7, in one embodiment, the player 10 then displays the image at about the same time as the corresponding audio broadcast. In addition, the redirect link is made available to provide access to a server containing additional information about the product or service advertised should the user click on the image. Optionally, one or more additional images are provided to the player for display, including an image of a coupon or the like, as well as related links for linking to additional servers in the case in which the user clicks on these additional images. At the conclusion of this process, a jump is made back to step 57.

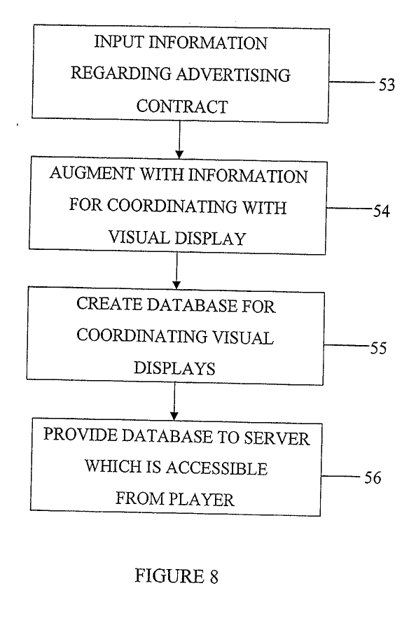

A method of operation of the set-up portion of FIG. 5 according to one embodiment is illustrated in FIG. 8. According to this method, a process of enabling the coordination in real time of a visual display with a corresponding audio advertisement broadcast is provided. With reference to FIG. 8, in step 53, information descriptive of an advertising contract with an advertiser is input into a database. Advantageously, a contract #, product or service name, advertiser name, and scheduled flight dates are input. In step 54, this information is augmented with additional information useful for coordinating a visual display with an audio broadcast of the advertisement. Advantageously, the information that is added can include, for each contract, one or more cut numbers, and for each cut number, an identifier of an image (or the image itself) to be displayed concurrently with the audio broadcast, and a redirect link for linking to a site in the event the user clicks on the image. In step 55, the foregoing information is entered into a database useful for enabling a real time coordinated visual display. In step 56, this database is provided to one or more servers that are accessible by the player 10. Although not shown expressly in FIG. 8, this database is used to implement the run-time process illustrated in FIG. 7. Specifically, this database is used to provide the flight dates used in the comparison indicated by step 59, and to also provide the image and redirect link indicated in step 60.

It should be appreciated that embodiments are possible in which additional functionality is provided by the continuity interface software in addition to that described above regarding coordinating visual displays with corresponding audio advertisement broadcasts. For example, in one embodiment, with reference to FIG. 5, a means is provided to allow the continuity interface to update, delete or modify records in table 37b resident on server 34 (within database 34b), and also to initiate the updating, deleting, or modifying of the corresponding records of the tables maintained on server 30. This might be useful in the event there is a change in a contract with an advertiser, or if the image for a spot has changed.

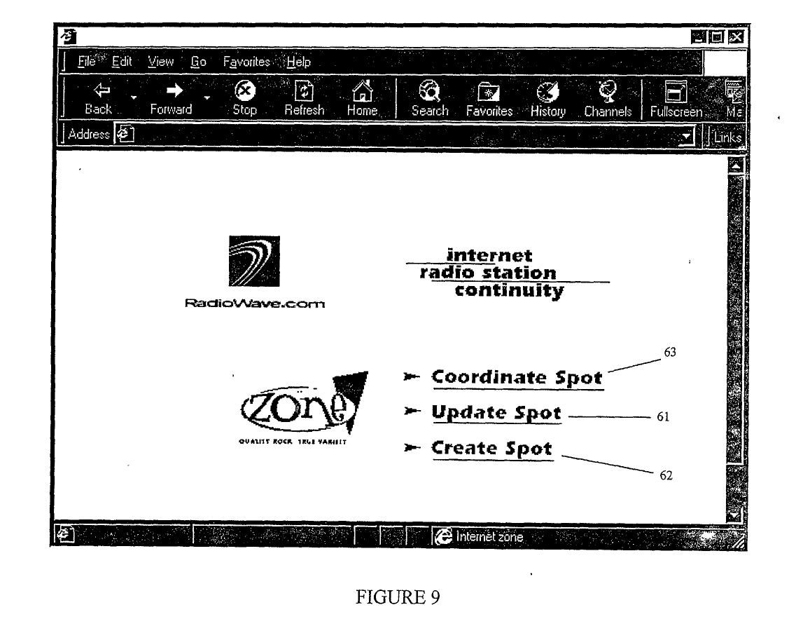

To utilize this functionality, with reference to FIG. 9, a user selects the update option 61 from a menu display in which other selections are offered. In the example of FIG. 9, a coordinate spot option 63 is also provided. This refers to the set-up system and process previously described and illustrated in FIGS. 5 and 7. In addition, a create spot option 62 is also provided which will be described later on. These selections can also be made from the server of FIG. 6, and other screens.

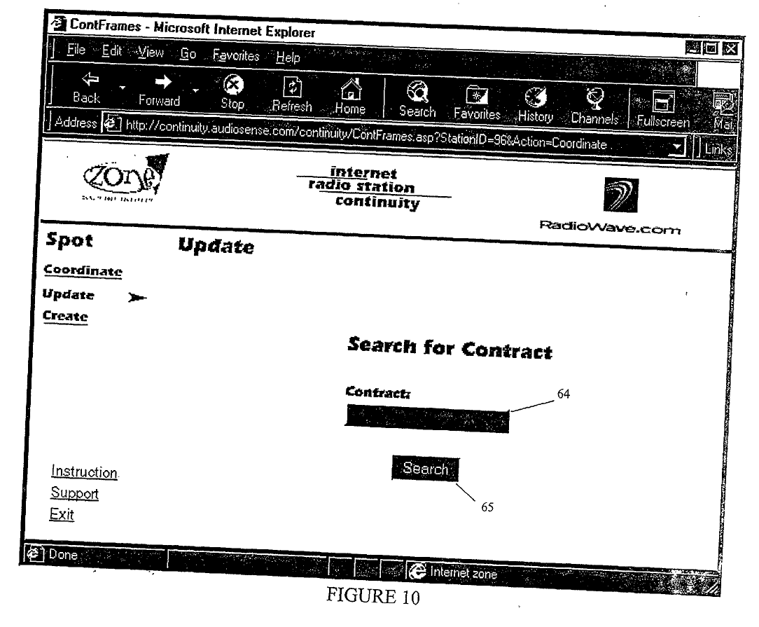

In one embodiment, to implement the update option, a screen such as that illustrated in FIG. 10 is first displayed. This screen provides a capability to search for the entries in the database corresponding to a specific contract. To use this capability, a user enters, at the location indicated by numeral 64 in FIG. 10, the contract number in question. The user then presses the search button identified with numeral 65 to begin the search. The system then searches through the databases 34a and 34b resident on server 34 until the records in question have been found. In one embodiment, the update option is only available with respect to coordinated spots, i.e., spots that have been coordinated with a visual display. However, it should be appreciated that embodiments are also possible in which uncoordinated spots are supported.

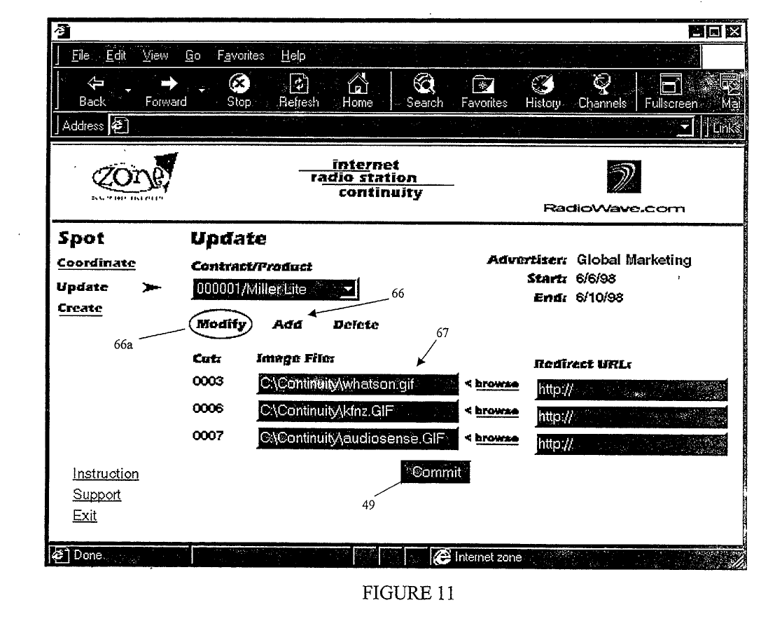

The system then displays the cuts or spots in the database that correspond to the specified contract. With reference to FIG. 11, the cuts corresponding to contract #0001, cuts 0003, 0006, and 0007, are displayed. The user is then given the opportunity to modify, add, or delete any or all of these records. Such is indicated by the option buttons 66, labeled “modify,” “add,” or “delete,” respectively, appearing above the display of the cuts or spots.

With reference to FIG. 11, assuming the user clicks on the “modify” button 66a, indicating a desire to modify one of the spots, the modify button is highlighted, and the user is then given the opportunity to update any of the information contained in the displayed cuts or spots. For example, with reference to FIG. 11, if the user wanted to change the image associated with cut #0003, he would simply substitute the new image name with the name indicated, i.e., “whatson.gif.” To implement the change, the user would then click on the commit button 49 discussed previously.

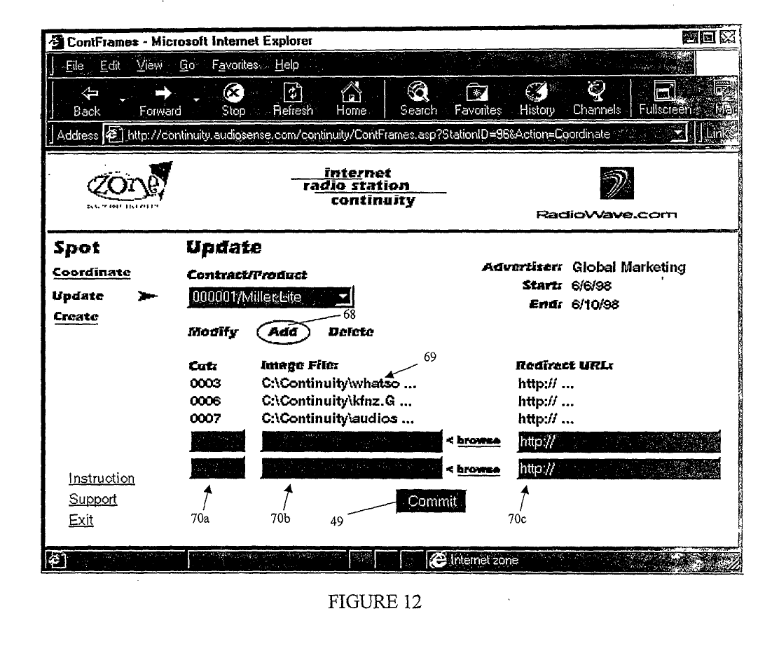

With reference to FIG. 12, assuming the user clicks on the “add” button 68, indicating a desire to add a cut to the cuts associated with an existing contract, the add button is highlighted, and the user is then given the opportunity to add to the information already stored for the contract in question. The existing cuts 69 for the contract in question are displayed, and the user is then prompted to add additional cuts for the contract. With reference to FIG. 12, as indicated by numerals 70a, 70b, and 70c, the user is prompted for the cut number, image name, and redirect link for any additional cuts. At the conclusion of this process, the changes can be implemented by clicking on the commit button 49 discussed previously.

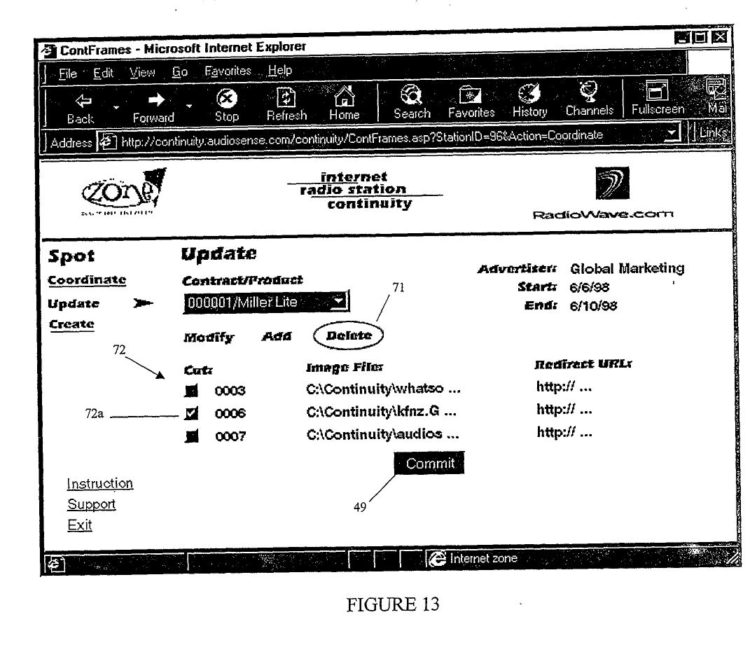

FIG. 13 illustrates a process of deleting a cut associated with a contract according to one embodiment. To select this option, the user clicks on the “delete” button, identified in the figure with numeral 71. The system then highlights the delete button 71, and displays the cuts associated with the contract in question. With reference to FIG. 13, the cuts associated with the contract in question, contract #0001, are displayed as indicated by numeral 72. A box is placed to the left of each cut. To delete a cut, the user clicks on the box. The system then places a check in the box to indicate that the deletion request has been recognized. Such is indicated by the checked box identified by numeral 72a in FIG. 13. To implement the change, the user then clicks on the commit button 49 in the manner described previously.

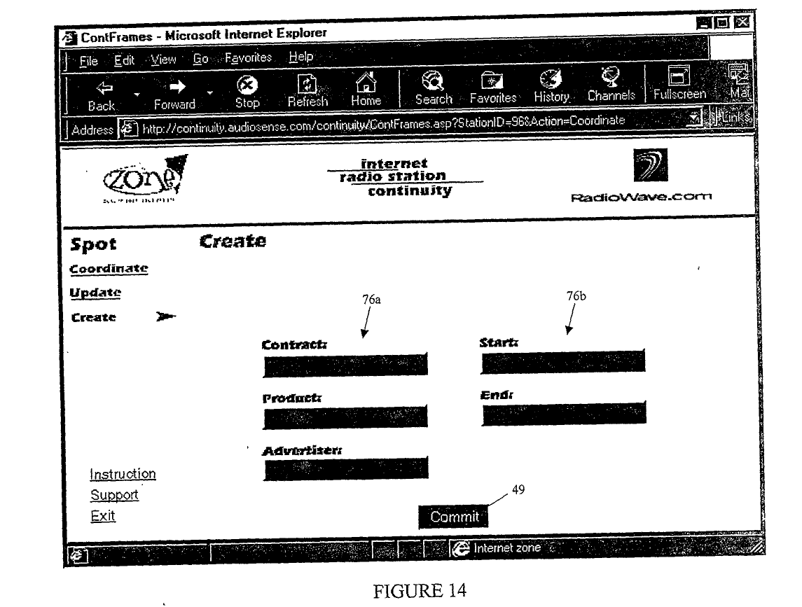

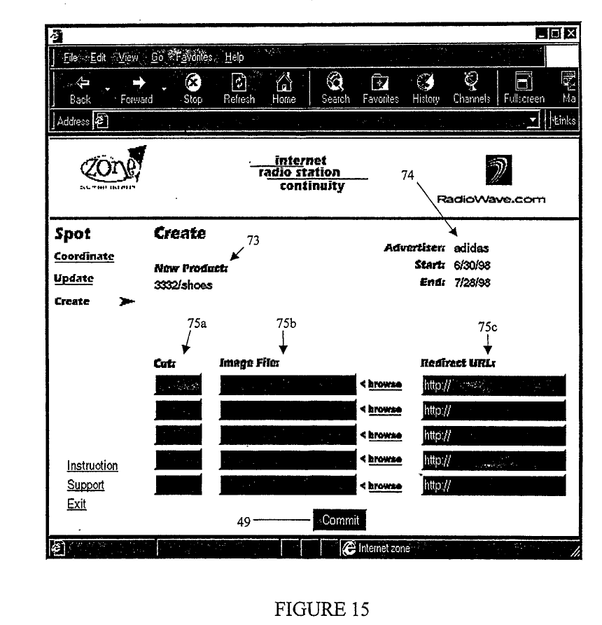

FIGS. 14 and 15 illustrate the process of creating new cuts according to one embodiment. With reference to FIG. 9, a user initiates this process by clicking on the “create spot” option 62. In one embodiment, this option is only selected as a last resort if there is a need to quickly coordinate a spot with a visual display, but there is no associated contract entered into the system. An example in which this feature might be useful is the case in which there is a desire to coordinate a spot for a contract entered into the database 33, but which has not yet been downloaded to the server 34 through the periodic FTP process described earlier. Responsive to a user selecting the create option indicated by numeral 62 in FIG. 9, the system displays a screen such as that indicated in FIG. 14. As indicated by numerals 76a and 76b, The user is prompted to enter the contract #, flight dates, advertiser, and product or service. After doing so, the user clicks on the commit button, which initiates the display, illustrated in FIG. 15. The advertiser and scheduled flight dates are displayed, as indicated by numeral 74 in FIG. 15, as well as the product/service name and contract #, as indicated by numeral 73. The user is then prompted for the information for the cuts associated with this product/service, including cut number, image name, and redirect link. Such is indicated by numerals 75a, 75b, and 75c in the figure. Finally, to implement the change, the user clicks on the commit button 49 in the manner described previously.

### EXAMPLE

Some aspects of an example implementation of the subject invention will now be described. According to this implementation, advertising server 30 executes scheduling software provided by NetGravity, Inc., www.netgravity.com, of Washington, D.C. The focus of this discussion is on some of the implementation details of API 44, the means for interfacing with the tables maintained by the NetGravity system, and related details of tables 37a and 37b resident on support server 34.

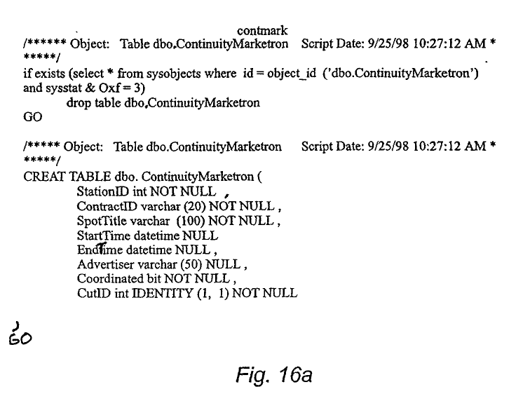

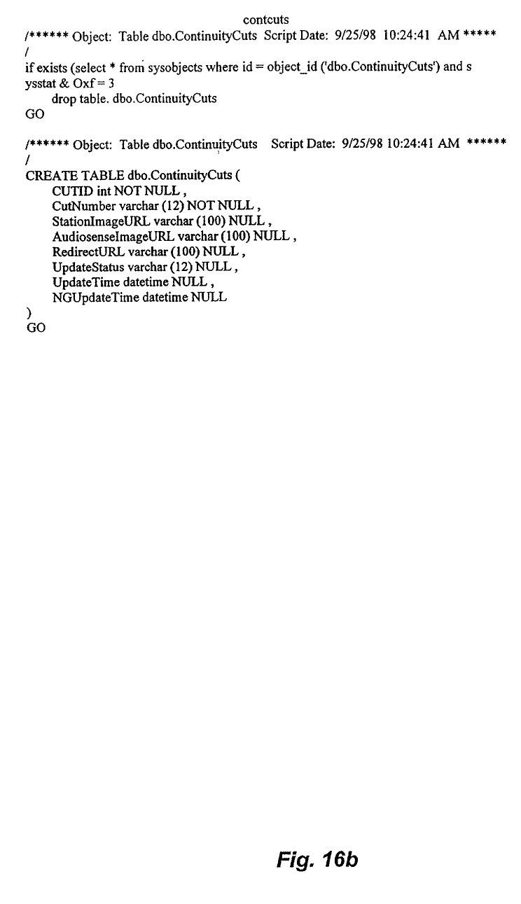

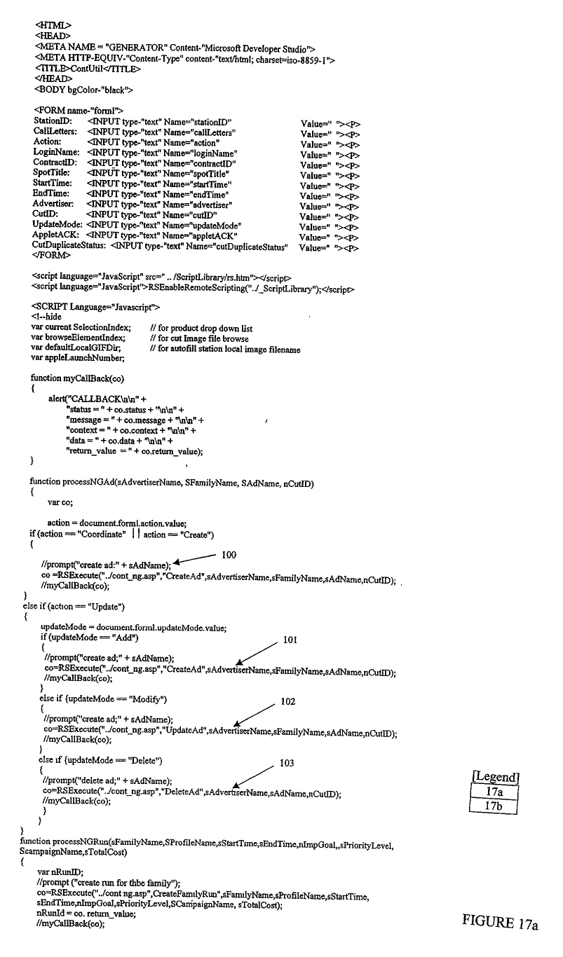

In this implementation, the fields of table 37a, one of the tables resident on server 34, are illustrated in FIG. 16a. As indicated, these fields include the station ID, contract ID, spot title (which is simply the name or the product or service being advertised), flight dates, advertiser name, Coordination Bit, and cut ID. The fields are identified in the figure with the names StationID, ContractID, SpotTitle, StartTime, EndTime, Advertiser, Coordinated Bit, and CutID, respectively. With the exception of CutID, each of these fields has been explained previously, and need not be described further here. The field CutID is an internal field that is used simply to correlate the records in table 37a with corresponding records in table 37b. It is not synonymous and should not be confused with the cut code or cut number, the number that uniquely identifies an audio segment from the standpoint of the radio station or other broadcaster.

The fields in this implementation of table 37b, another of the tables resident on server 34, are illustrated in FIG. 16b. These fields are identified with the names CutID, CutNumber, StationImageURL, AudiosenseImageURL, RedirectURL, UpdateStatus, UpdateTime, and NGUpdateTime. The CutID is the field described previously used to coordinate table 37a with table 37b. CutNumber is the cut code or cut number described previously used to identify a particular audio segment from the standpoint of the broadcaster. The field StationImageURL is used to store the file name of the image as stored on the file system of workstation 35a. The field AudiosenseImageURL is a link to an image for the spot resident on image server 30. RedirectURL is the link to additional information about the product or service being advertised resident on server 32. The remaining fields are used internally and need not be described further for an understanding of the invention.

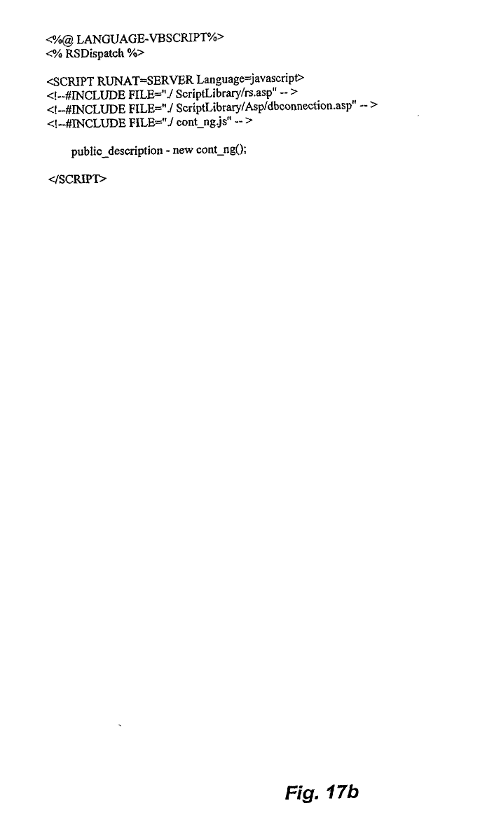

FIGS. 17a-17b illustrate software code which, in the example implementation, is part of the continuity interface software resident on continuity server 35b. This software is executed when the commit button 49 illustrated in the foregoing previously described screen shots is clicked on, invoking API 44 to update the tables maintained on advertising server 30.

With reference to FIG. 17a, numeral 100 identifies a subroutine call to the CreateAd routine of API 44 which is invoked when a user desires to either to coordinate a visual display with an audio advertisement, or create a record for such a visual display. The coordination function was described previously in relation to the screen shot illustrated in FIG. 6, and the create function was described previously in relation to the screen shots illustrated in FIGS. 14 and 15. Briefly, the coordination function correlates information input through a broadcast advertising system, such as the Marketron system, i.e., the table 37a information described previously, with information input through the continuity interface, i.e., the table 37b information described previously. The create function allows a user to input through the continuity interface both the information maintained in tables 37a and 37b. In both cases, records must be created in the tables maintained by the NetGravity system on the advertising server 30 for correlating the cut number with the image link and redirect URL or other link for the advertisement, and for maintaining other information related to the advertisement, such as scheduled flight dates, advertiser name, product or service name, etc. The CreateAd routine in the API 44 is invoked to accomplish this objective.

Numeral 101 identifies another call to the CreateAd routine in the API 44 responsive to a user desiring to add a record for a cut or spot. As described previously in relation to FIG. 12, the add function allows a user to input into table 37b additional records for a contract ID and product/service combination. The CreateAd routine is invoked to add these additional records to the tables maintained by the NetGravity system on advertising server 30.

Numeral 102 identifies a call to the UpdateAd routine in the API 44 responsive to a user selecting the modify function. As previously described in relation to FIG. 11, the modify function allows a user to update records of table 37b for a contract ID/product or service combination. The UpdateAd routine simply updates the corresponding table(s) maintained by the NetGravity system on advertising server 30 with this updated information.

Numeral 103 identifies a call to the DeleteAd routine in the API 44 responsive to a user selecting the delete function. As previously described in relation to FIG. 13, the delete function allows a user to delete from table 37b records for a contract/product or service combination. The DeleteAd routine simply deletes the corresponding records from the table(s) maintained by the NetGravity system on advertising server 30.

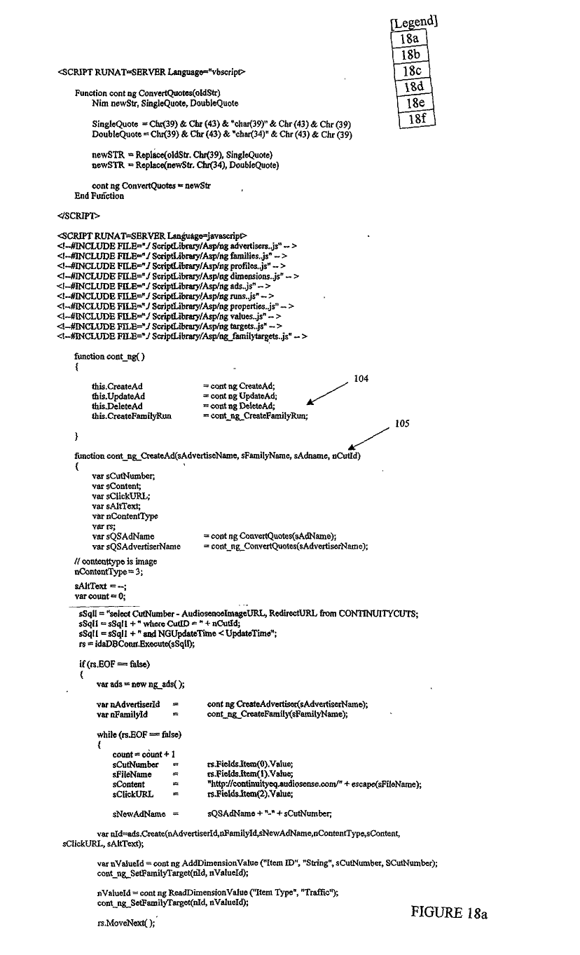

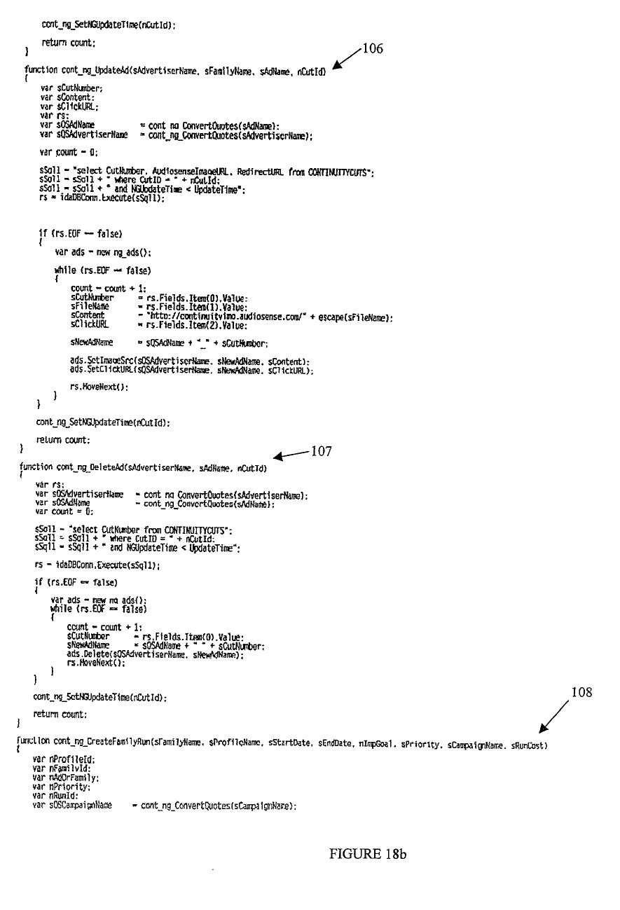

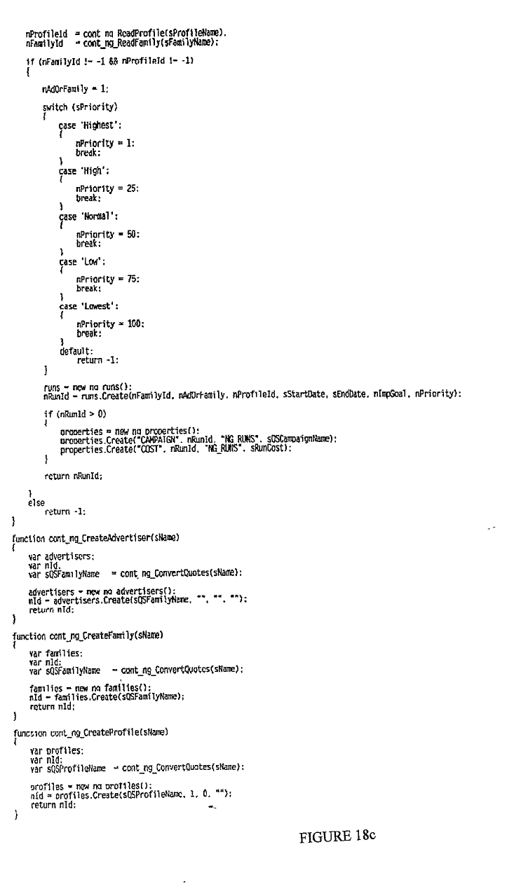

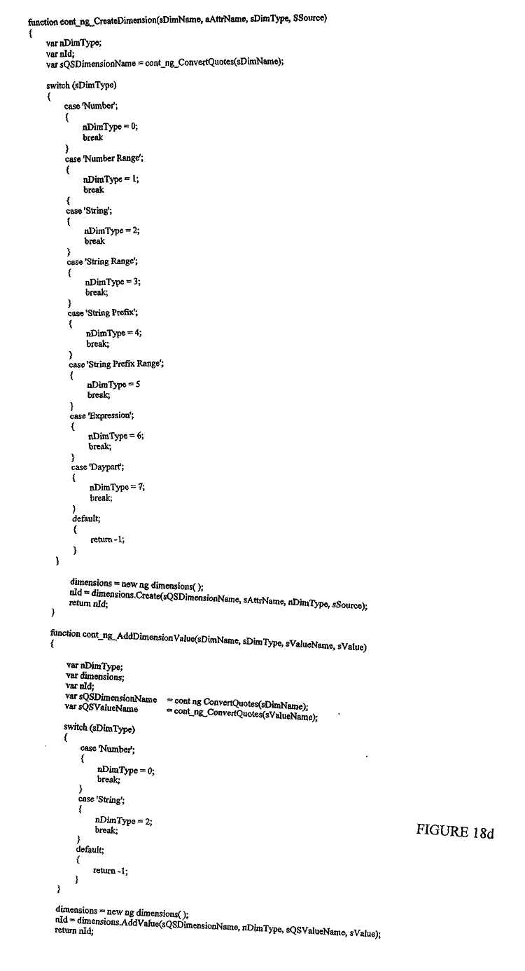

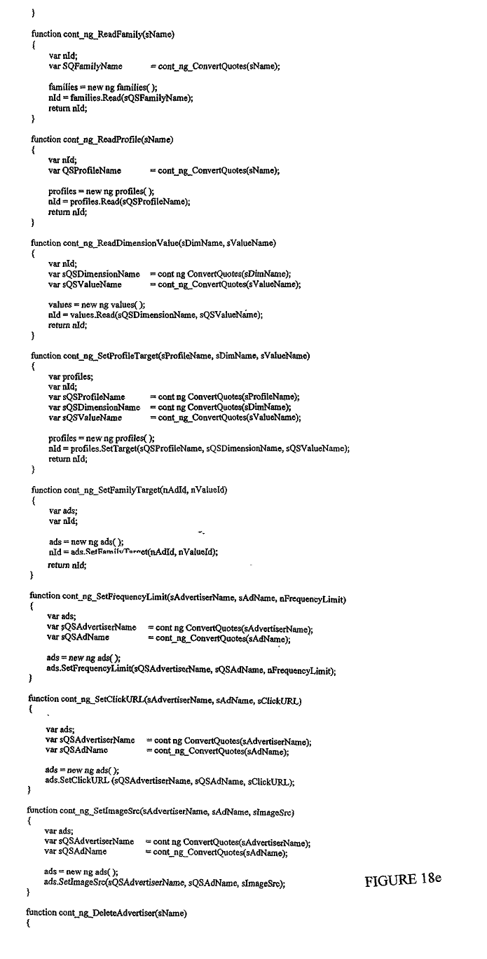

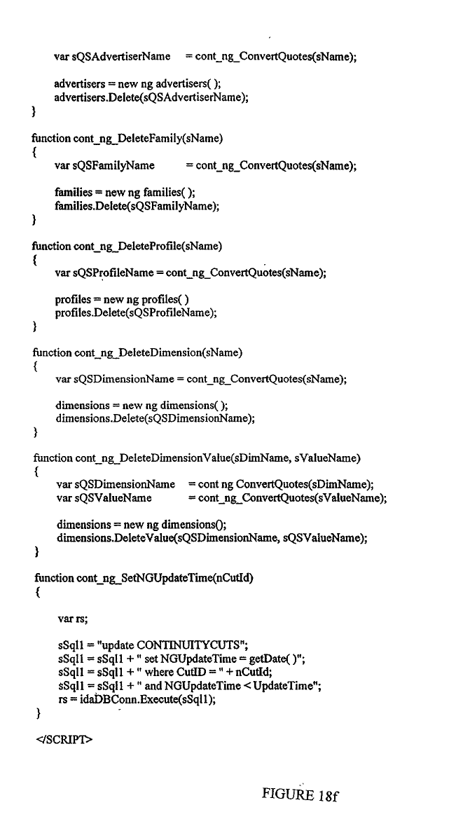

FIGS. 18a-18f illustrate software code which is part of the front-end of API 44, i.e., the portion of the code which responds to the functions initiated through the software in the continuity interface illustrated in FIGS. 17a-17b. In this implementation, this code is resident on continuity server 35b although it is part of API 44 rather than the continuity interface that is also resident on this server.

With reference to FIG. 18a, numeral 104 identifies the four principal routines embodied by this code: the CreateAd, UpdateAd, DeleteAd, and CreateFamilyRun routines. The CreateAd, UpdateAd, and DeleteAd routines are the same routines that have already been described above in relation to the software illustrated in FIGS. 17a-17b. Again, the purpose of these routines is simply to perform the front-end tasks needed to implement the create, coordinate, modify, add, and delete functions initiated by a user. With reference to FIG. 18a, the code which embodies the CreateAd routine is the section of code beginning with the code identified with numeral 105. With reference to FIG. 18b, the code which embodies the UpdateAd routine is the section of code beginning with the code identified with numeral 106. Also with reference to FIG. 18c, the code which embodies the DeleteAd routine is the section of code beginning with the code identified with numeral 107.

The CreateFamilyRun routine is employed to update the tables in the advertising server 30 with the scheduled flight dates for an advertisement. In the example implementation, it is invoked only after a successful invocation of the CreateAd function, but is not independently invoked. Thus, in this implementation, the process of coordinating a visual display with an audio advertisement is a two-step process. First, entries for the visual display are created using the CreateAd routine. Second, after this has been successfully accomplished, the display of the visual material is scheduled using the CreateFamilyRun routine. With reference to FIG. 18b, the section of code which embodies the CreateFamilyRun routine begins with the code identified with numeral 108. Other front-end functions are performed by the code sections listed on FIGS. 18c-18f, but, since they are not necessary to understand the invention, need not be explained further.

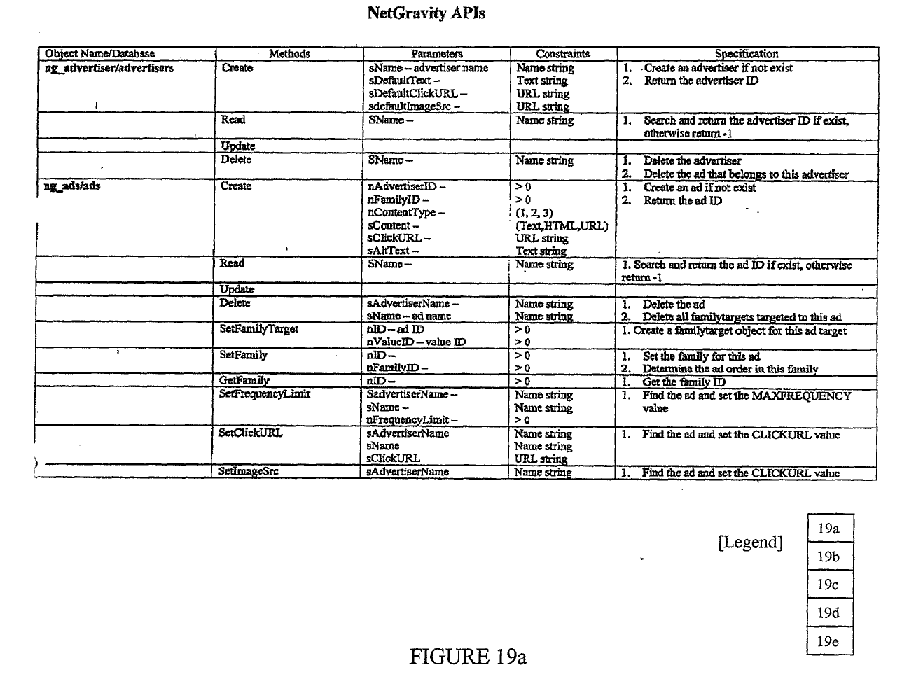

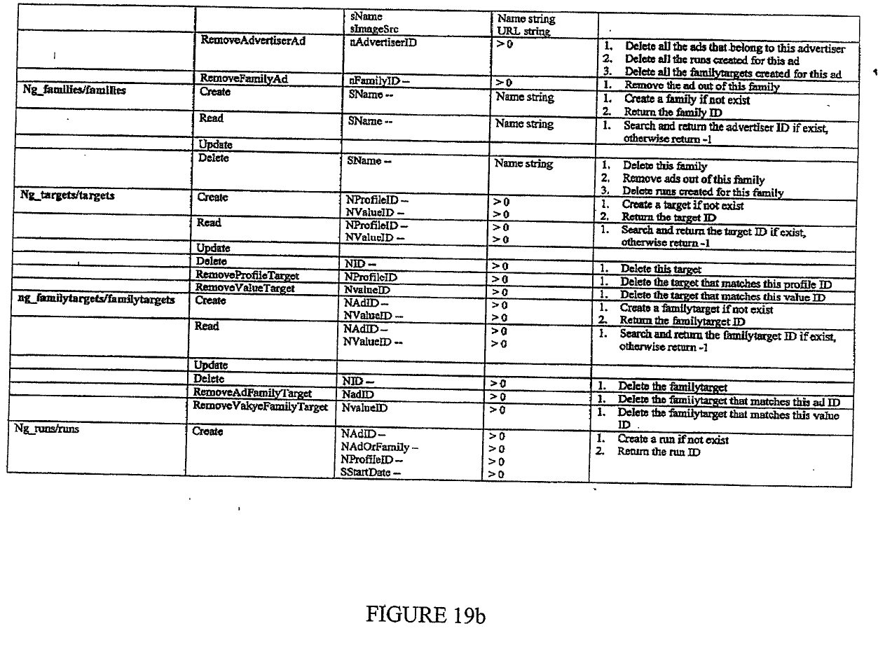

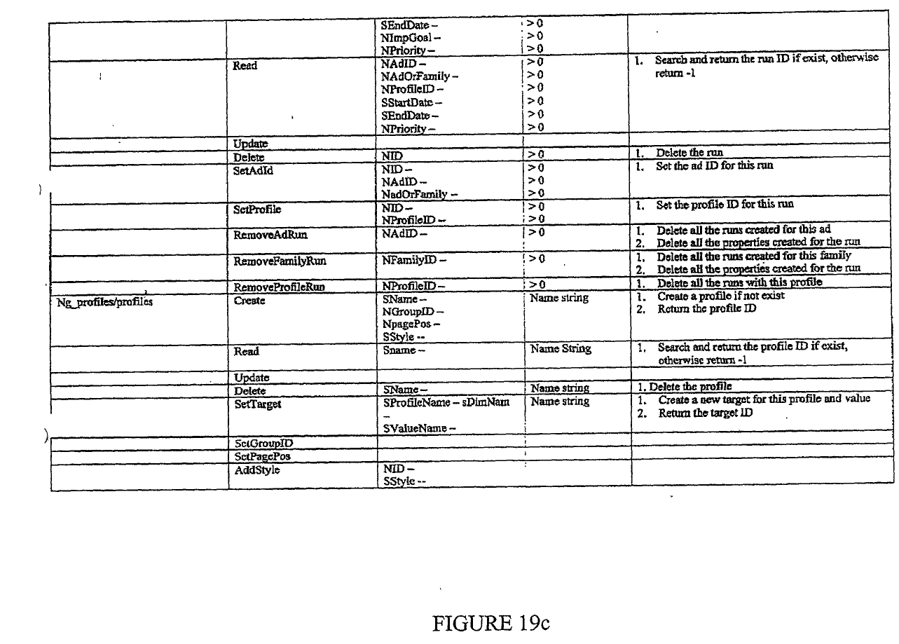

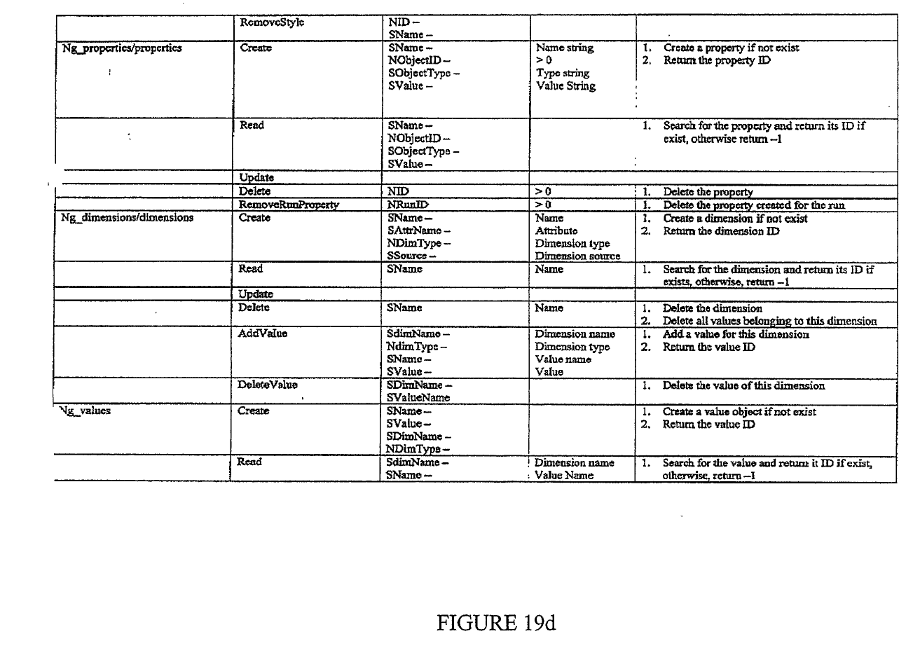

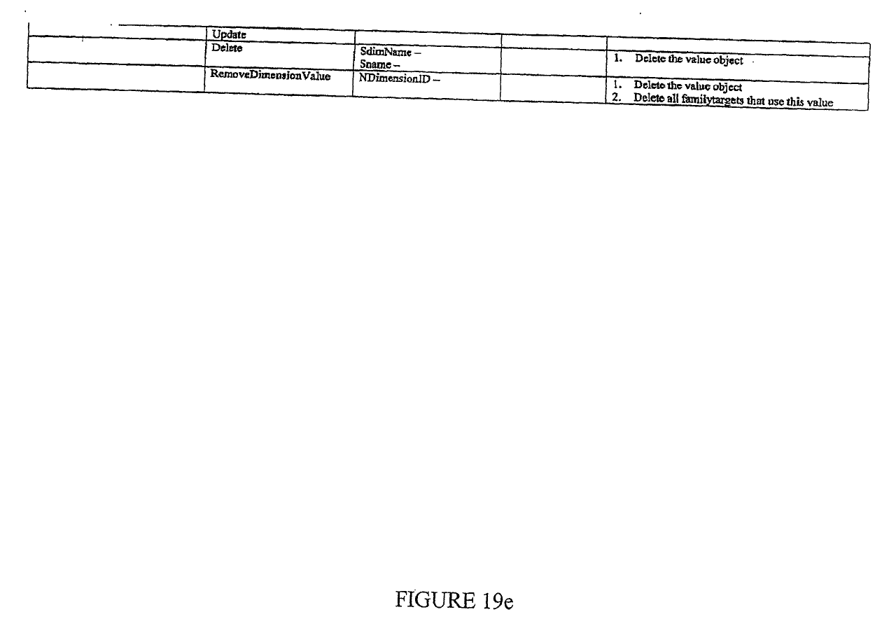

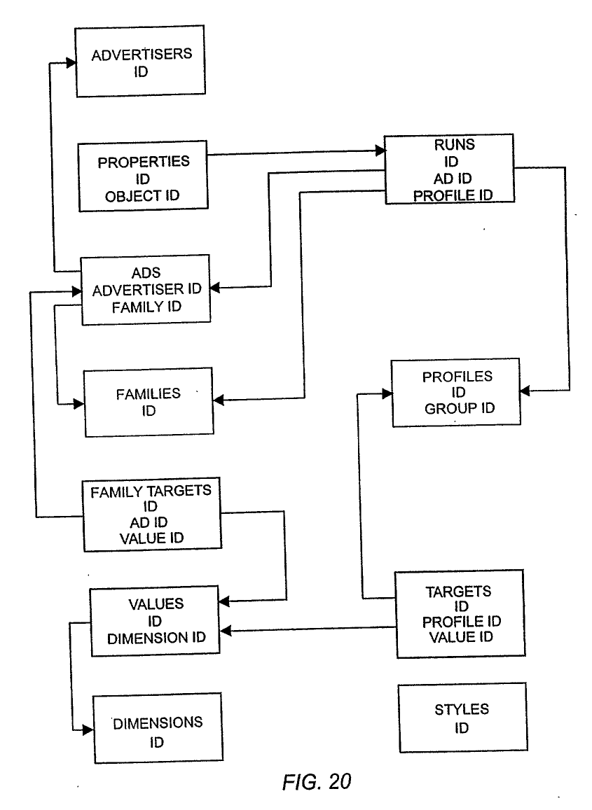

FIGS. 19a-19e functionally describe the back-end tasks performed by API 44. These back-end tasks are performed responsive to the front-end tasks performed by the code of FIGS. 18a-18f, which are themselves performed responsive to user commands initiated through the continuity interface. These back-end tasks are the specific tasks performed to update the tables maintained by the NetGravity system in the example implementation. The tables maintained by the NetGravity system are illustrated in FIG. 20.

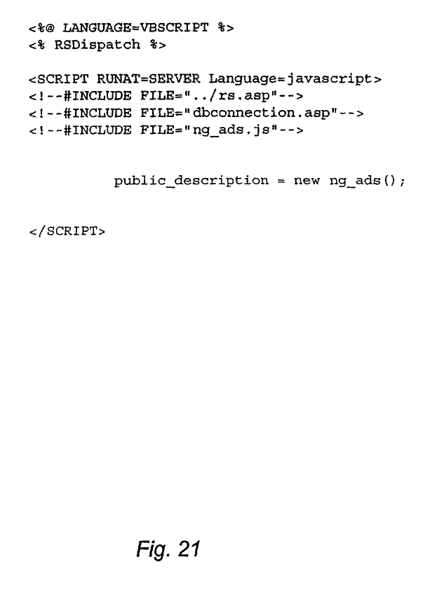

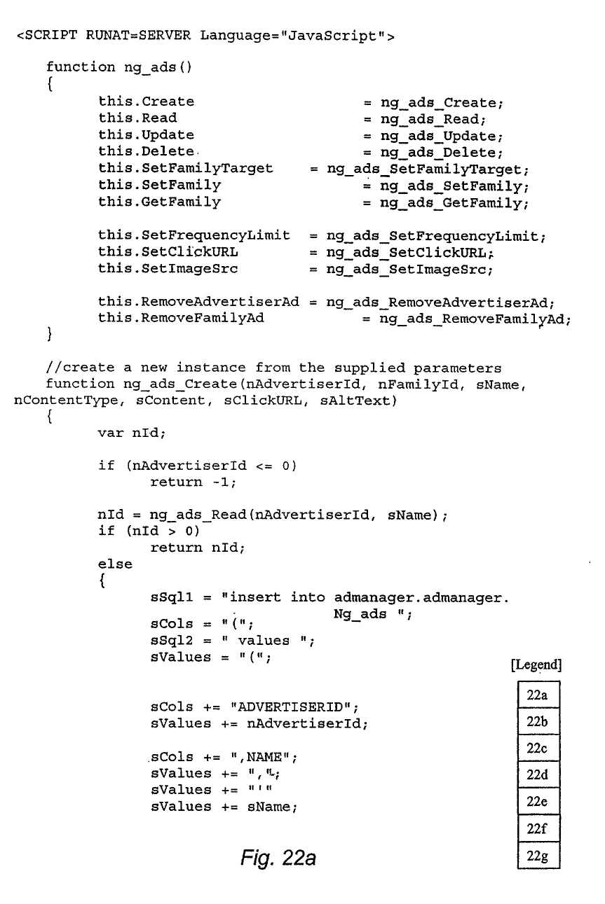

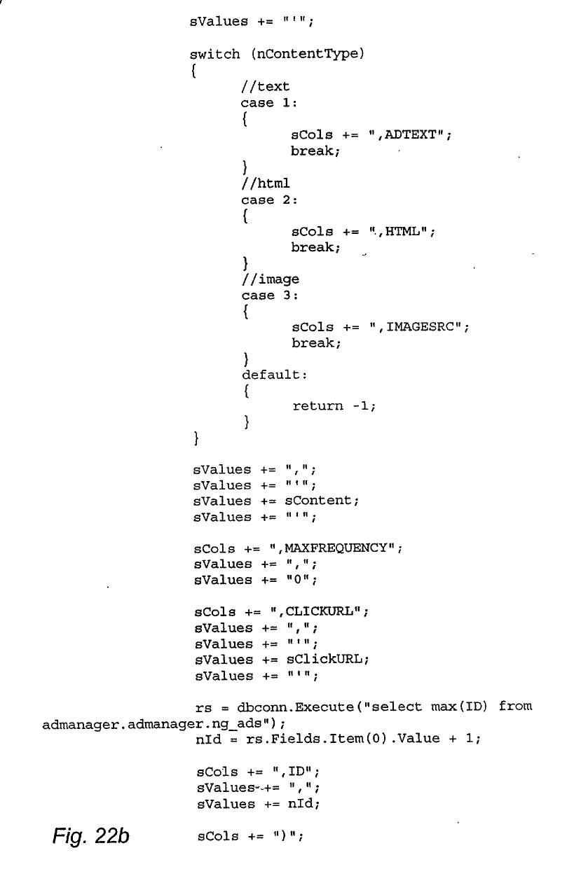

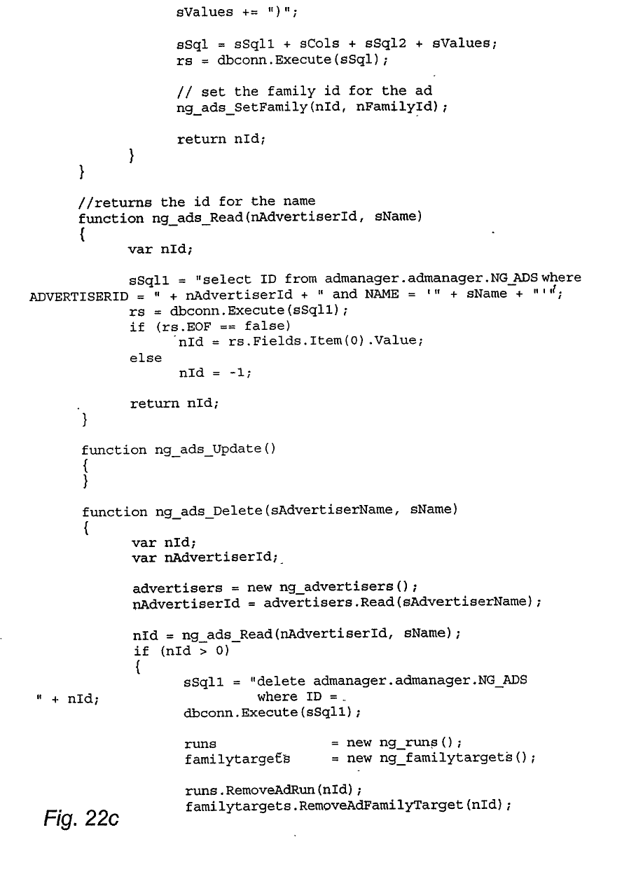

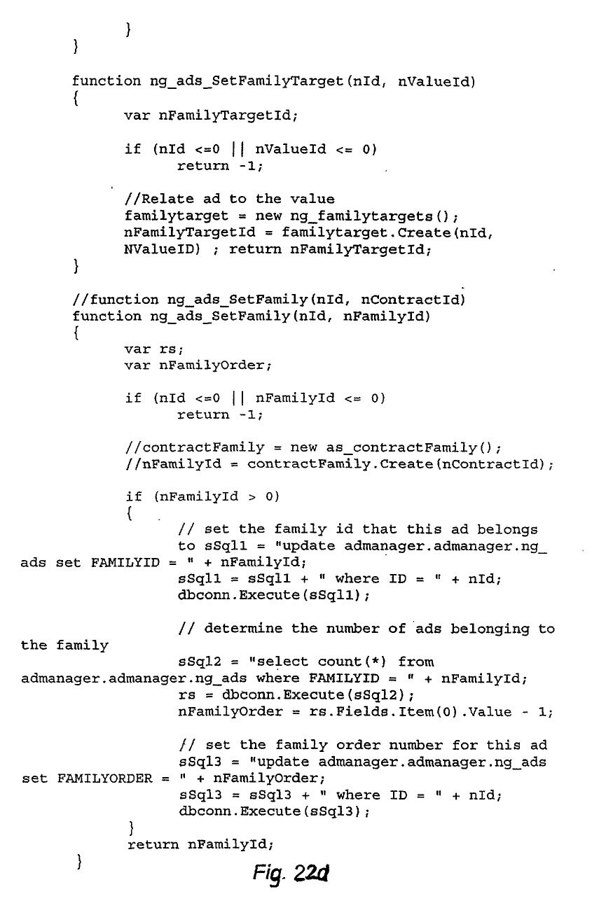

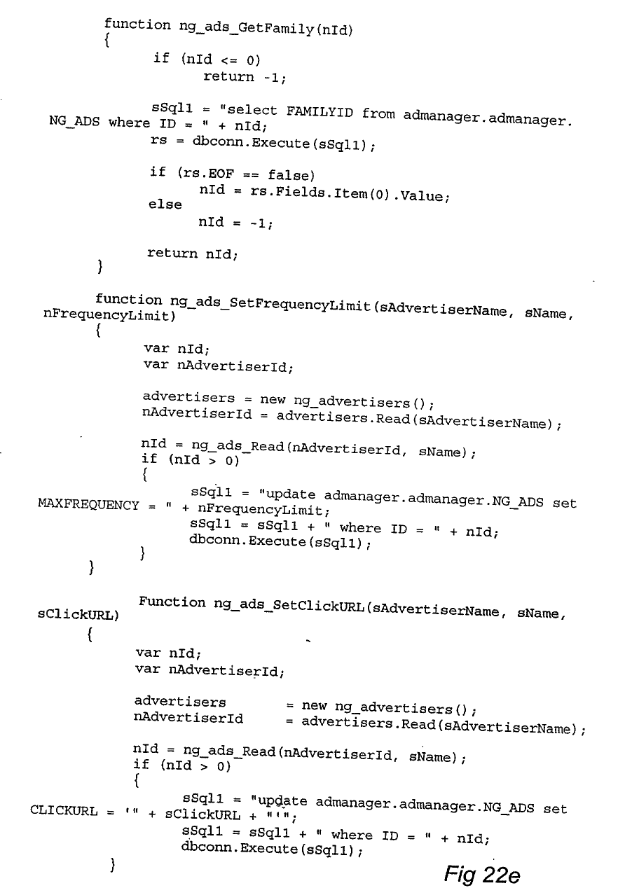

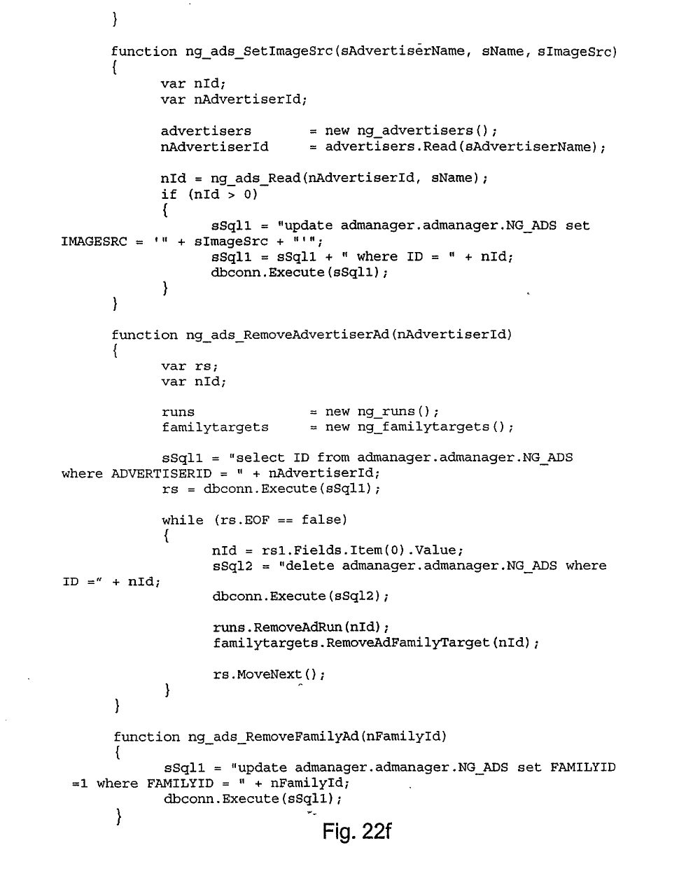

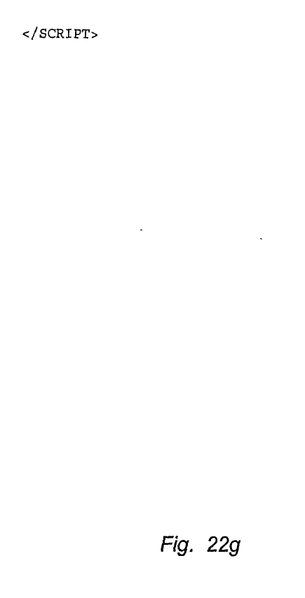

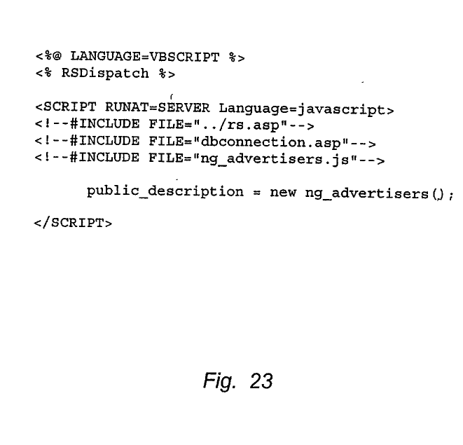

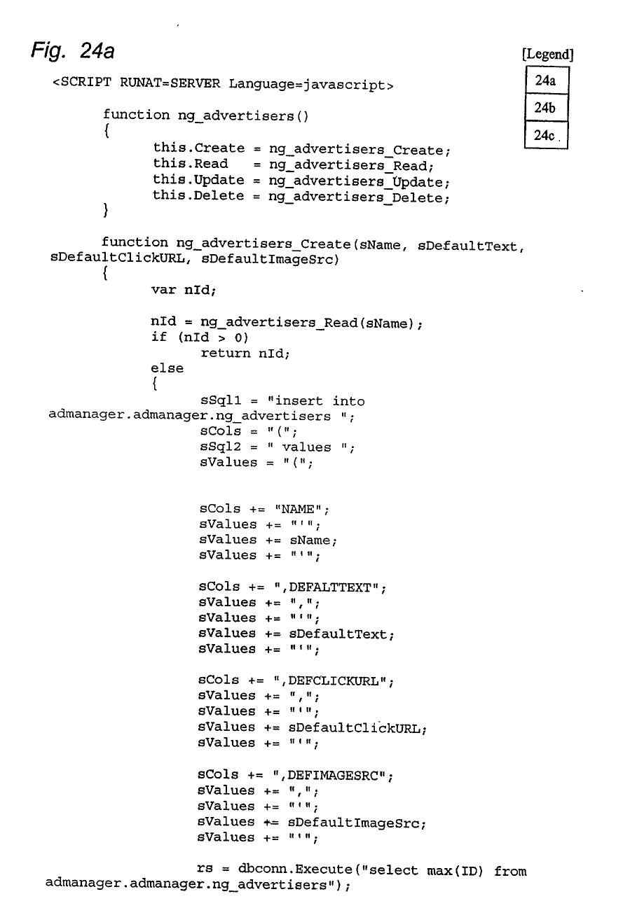

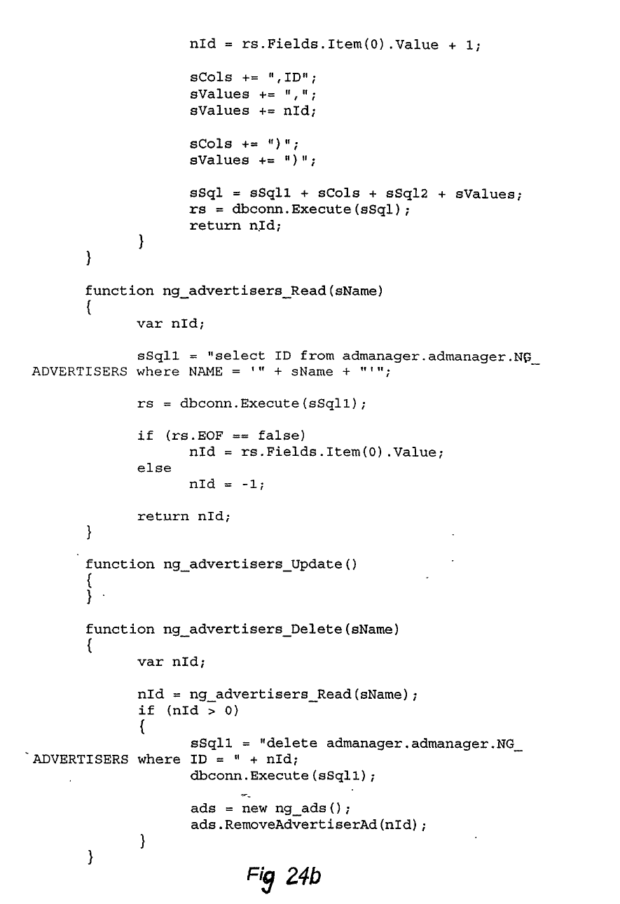

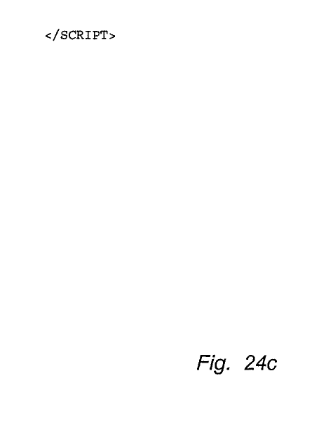

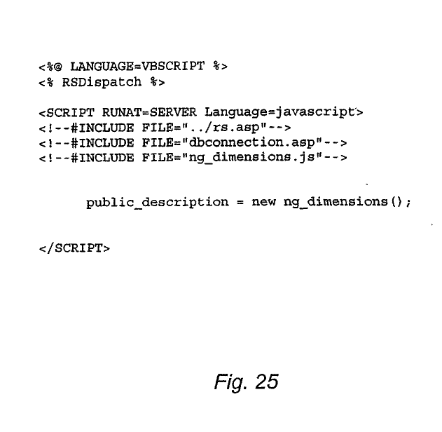

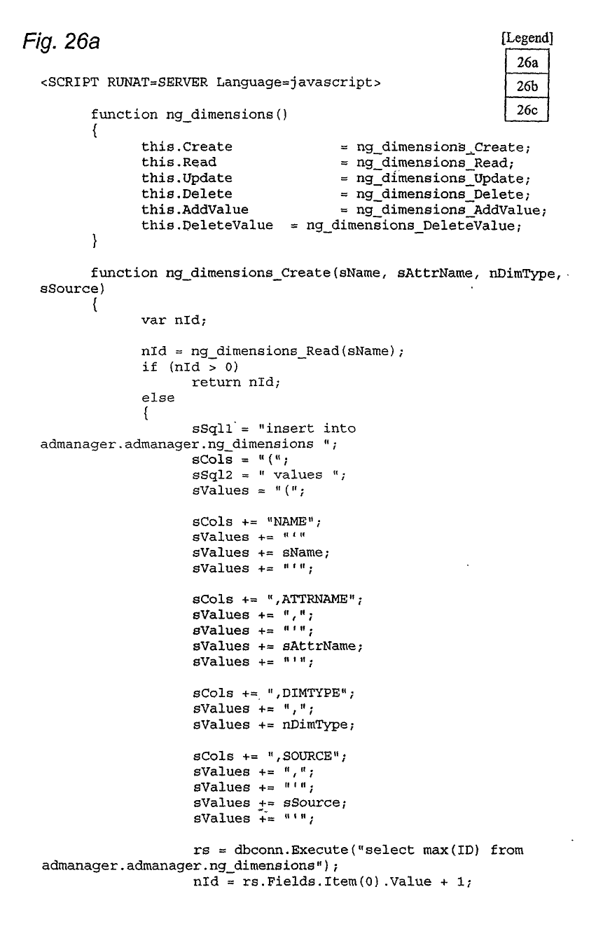

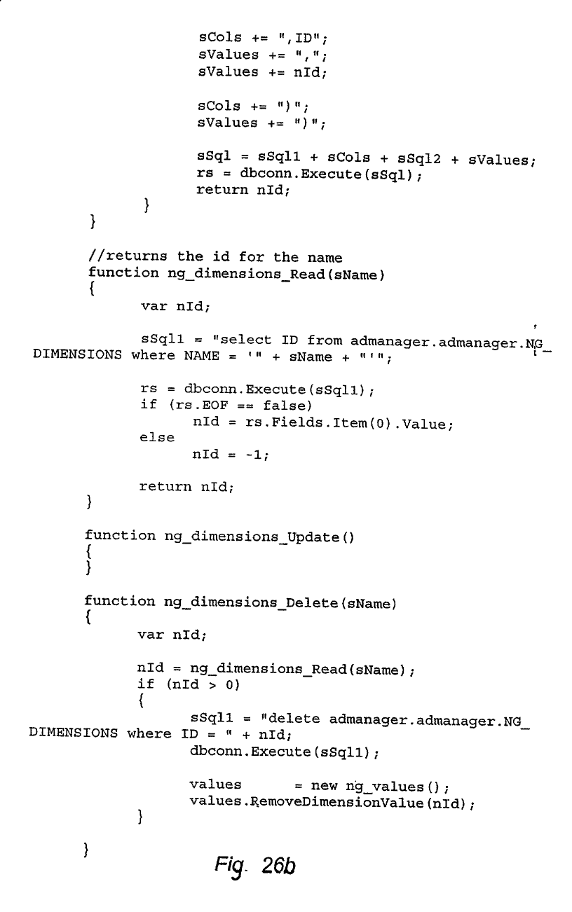

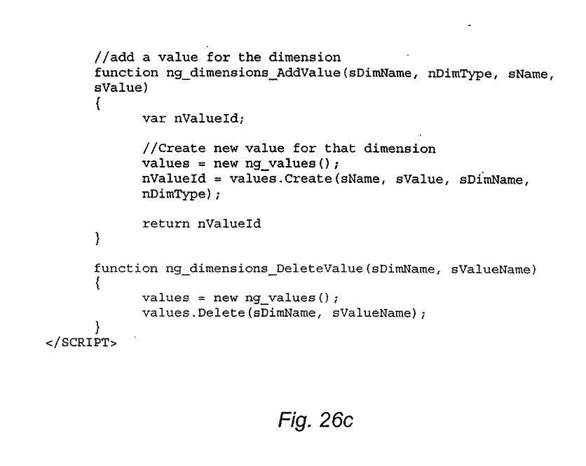

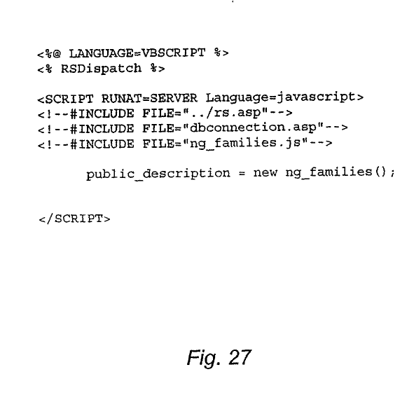

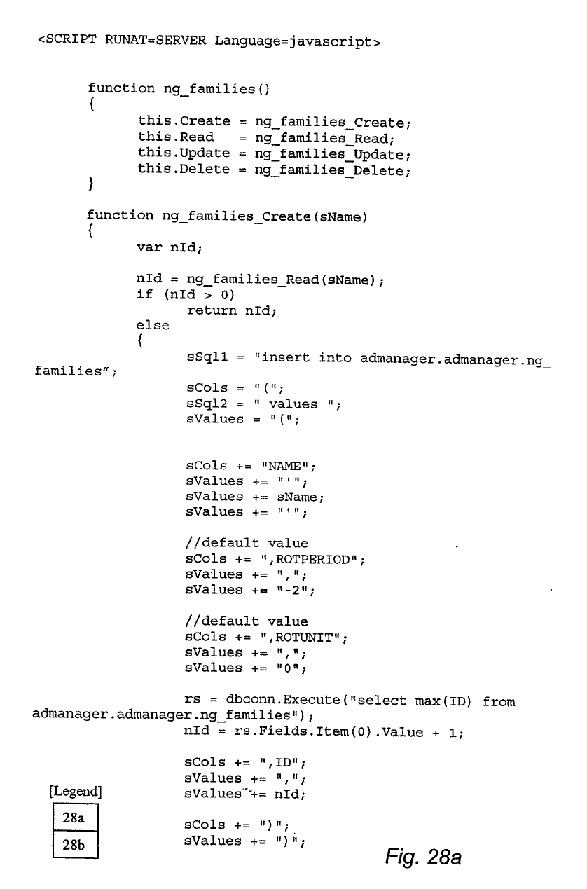

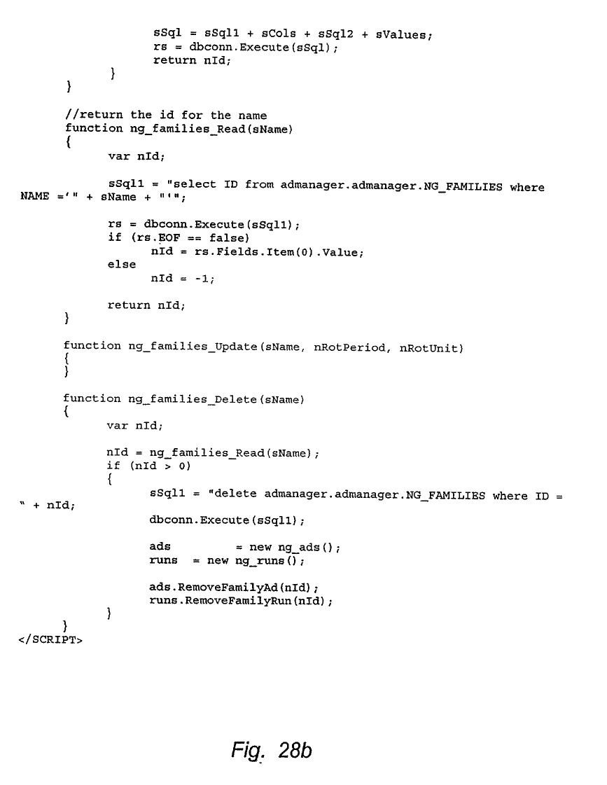

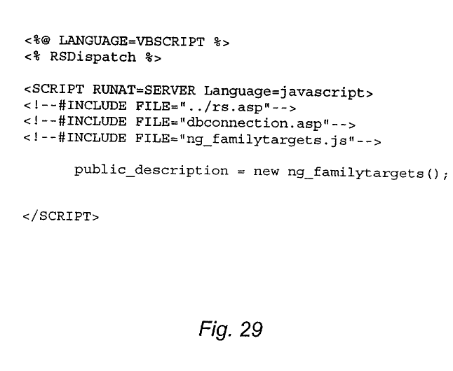

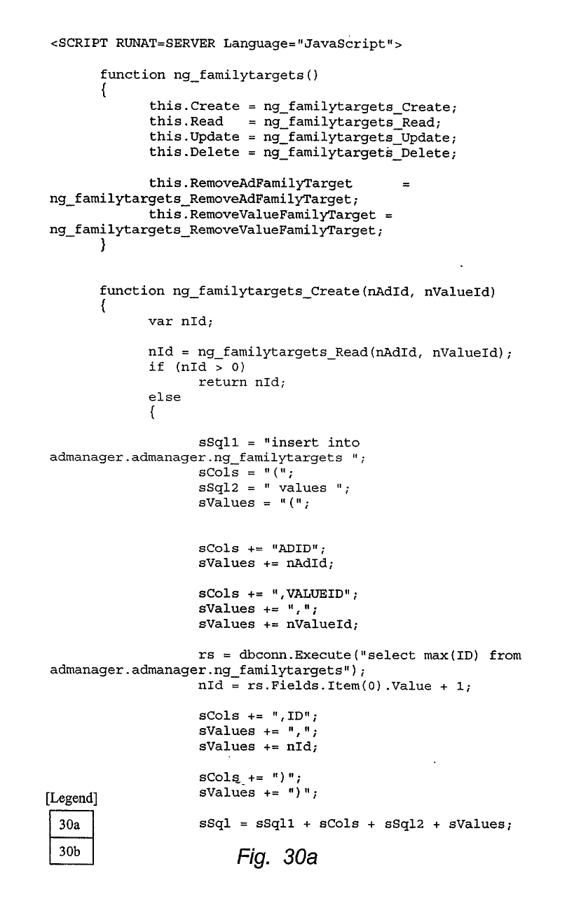

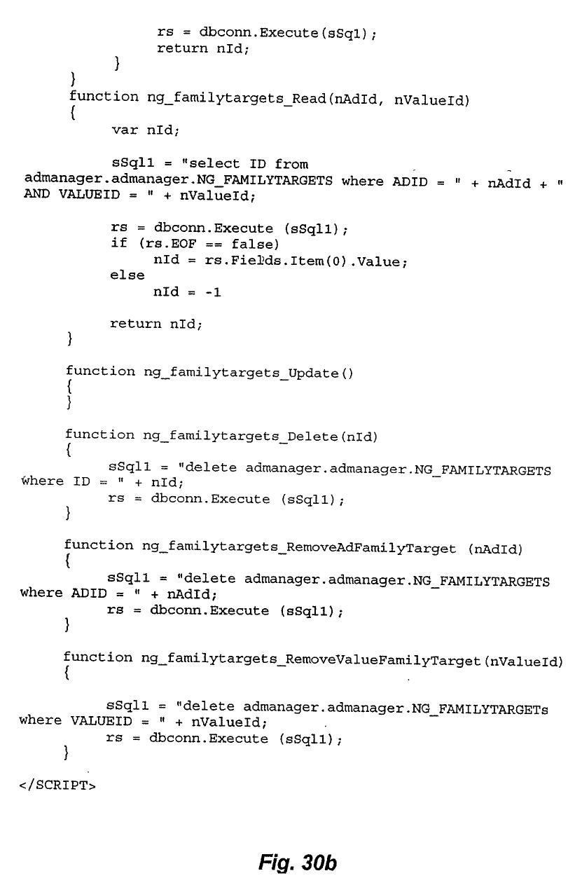

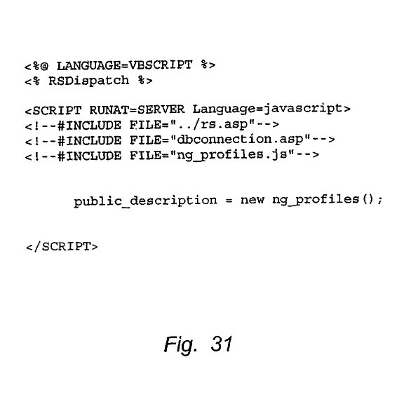

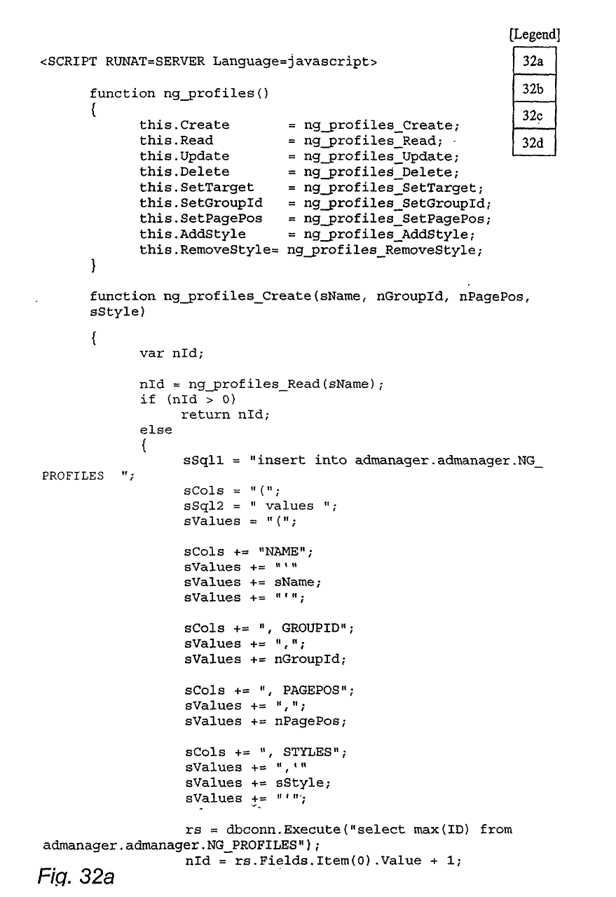

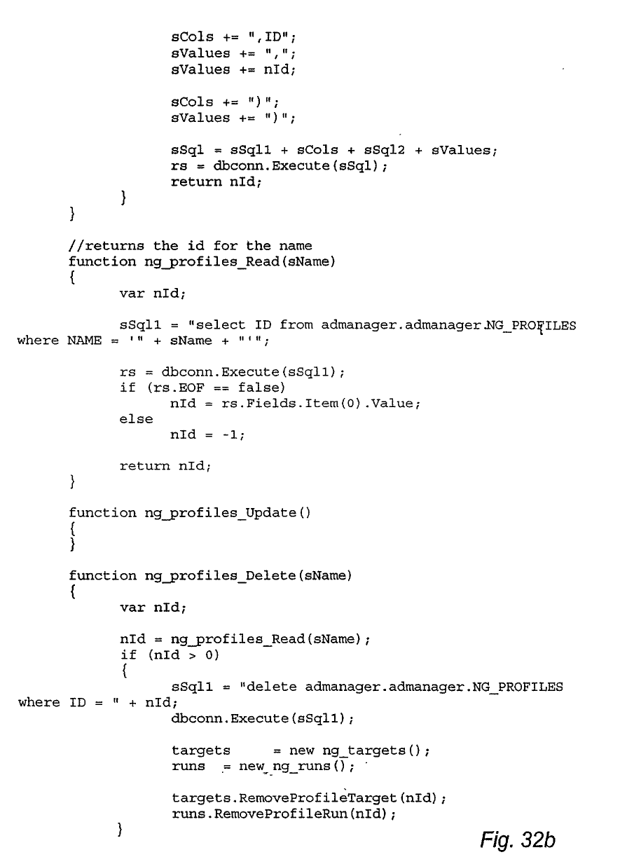

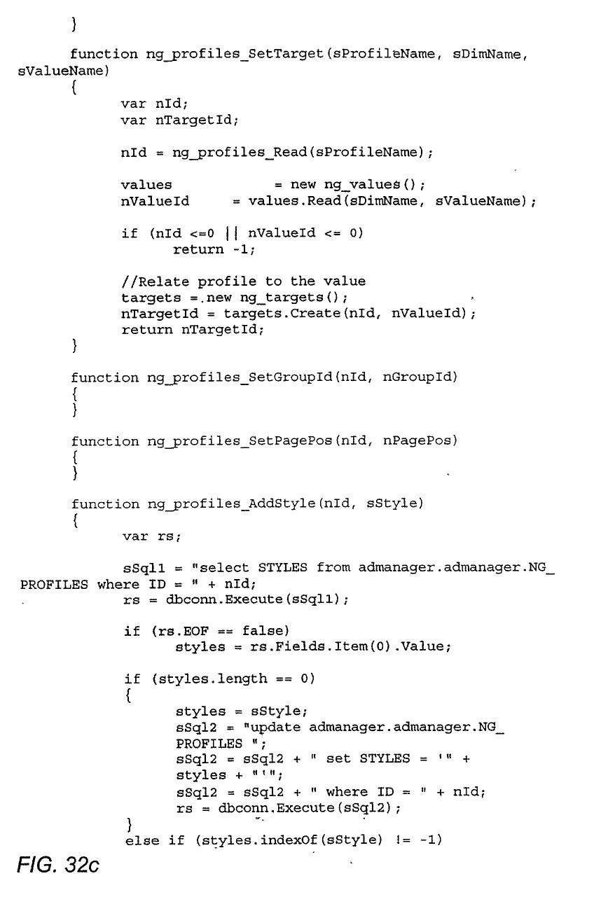

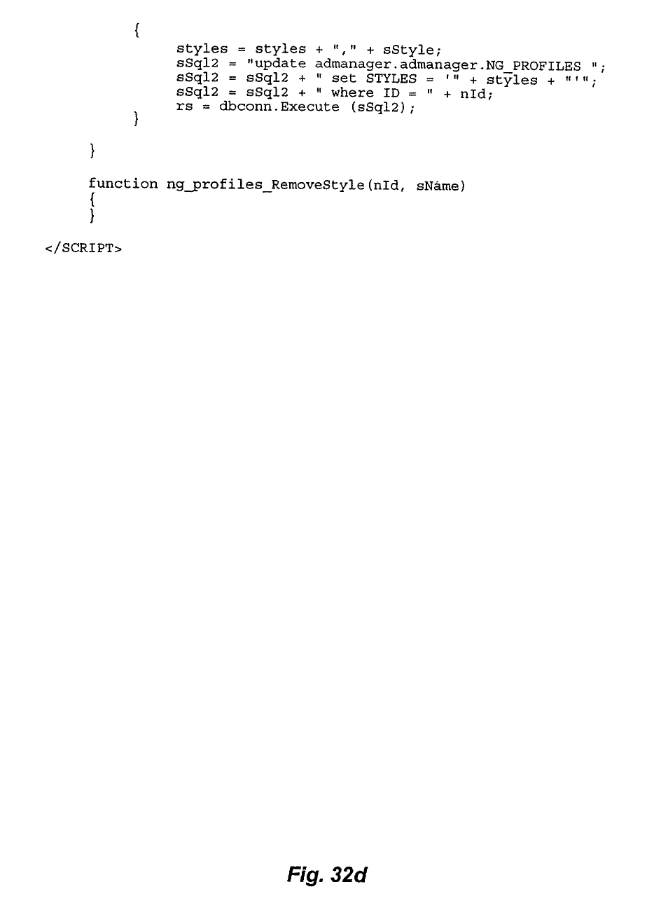

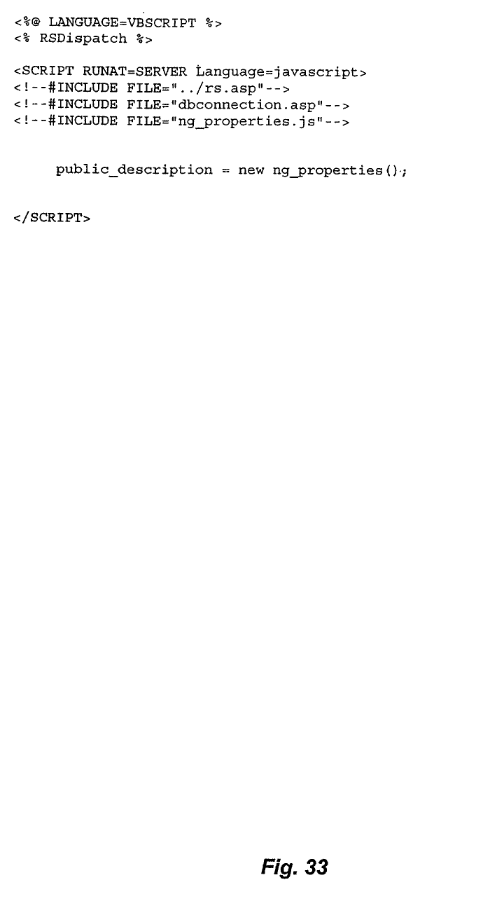

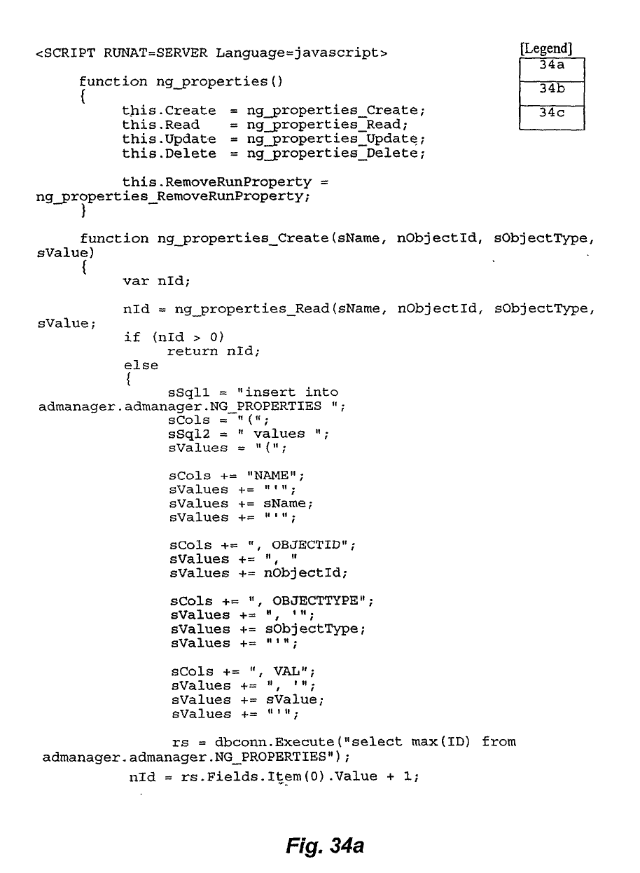

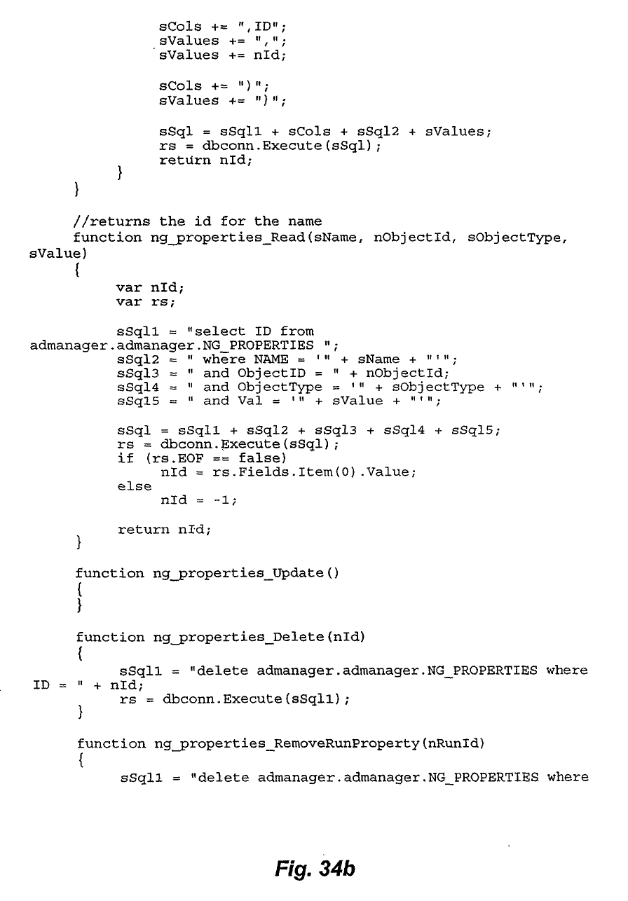

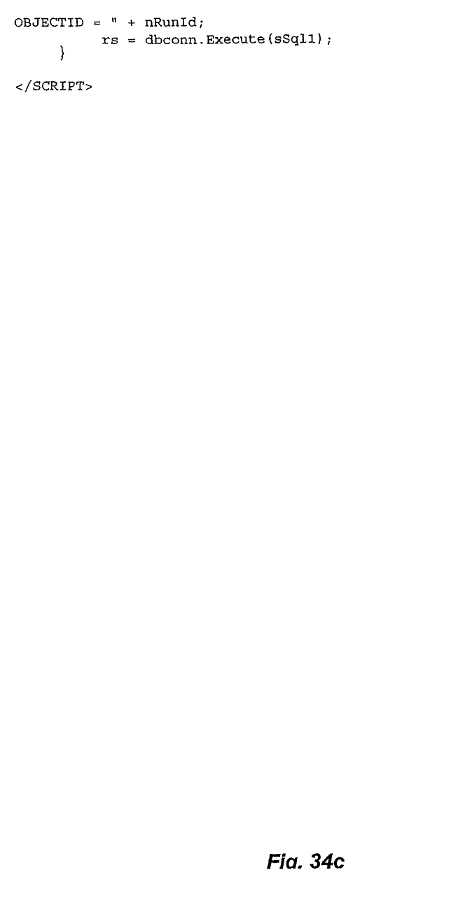

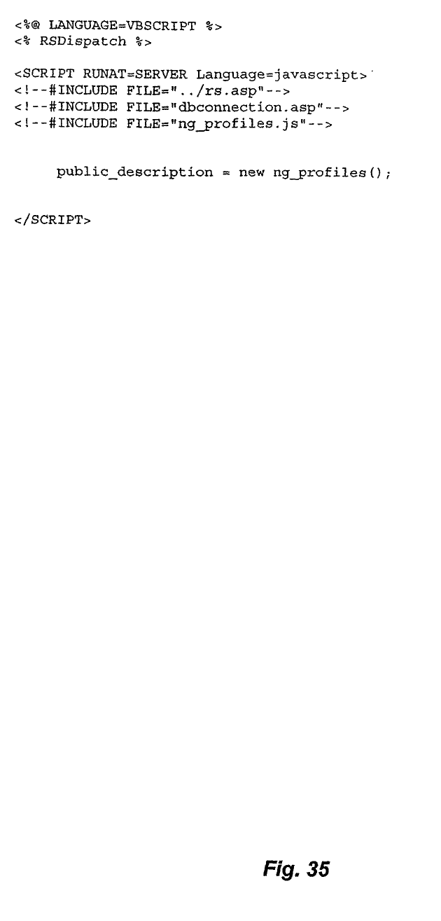

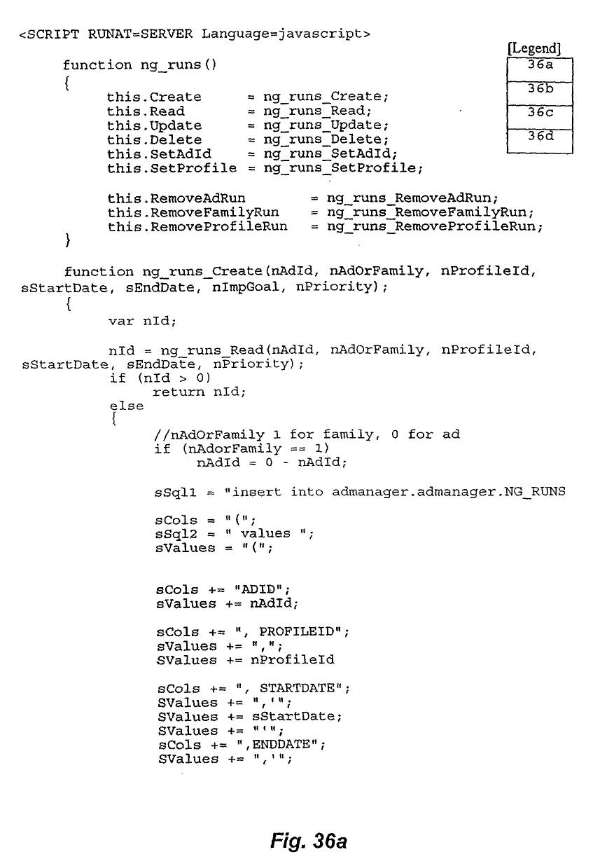

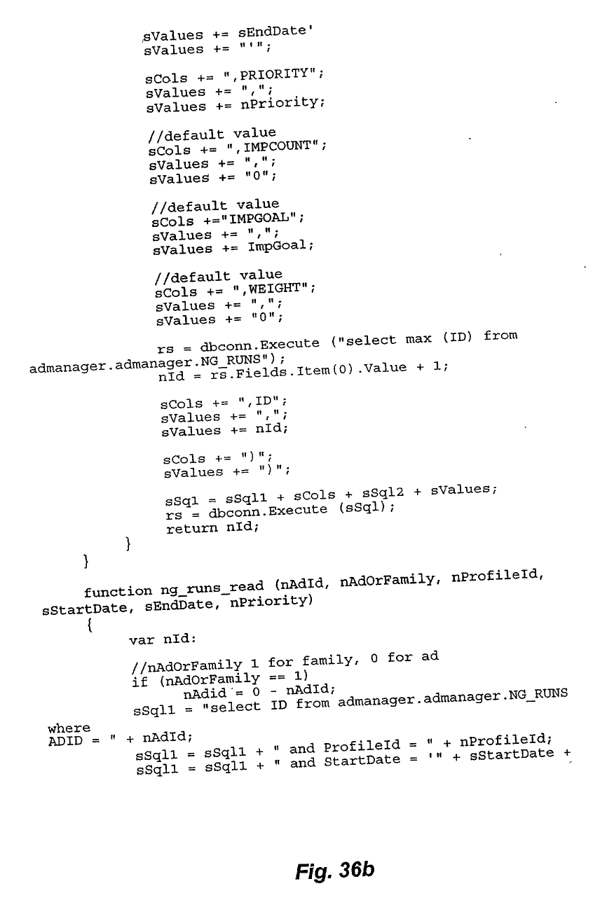

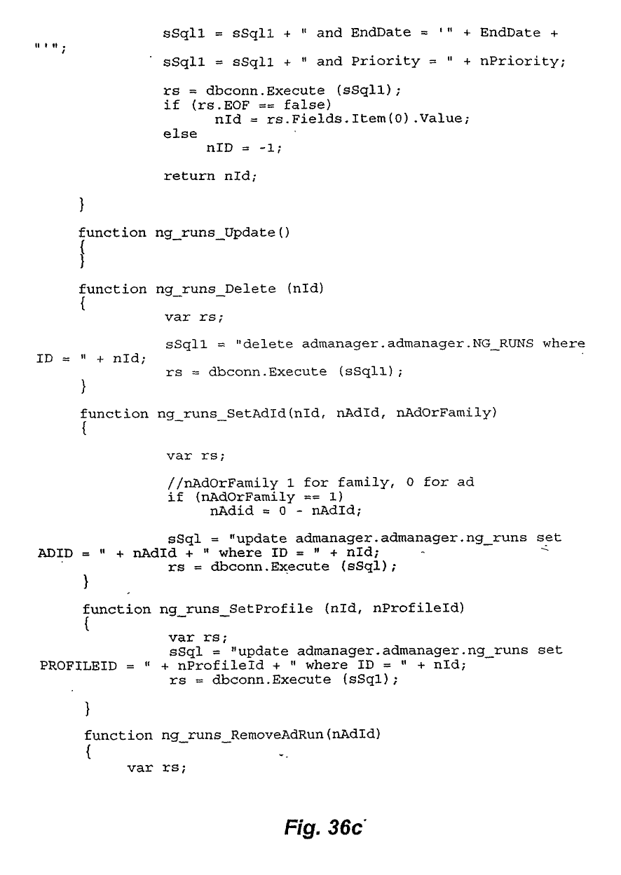

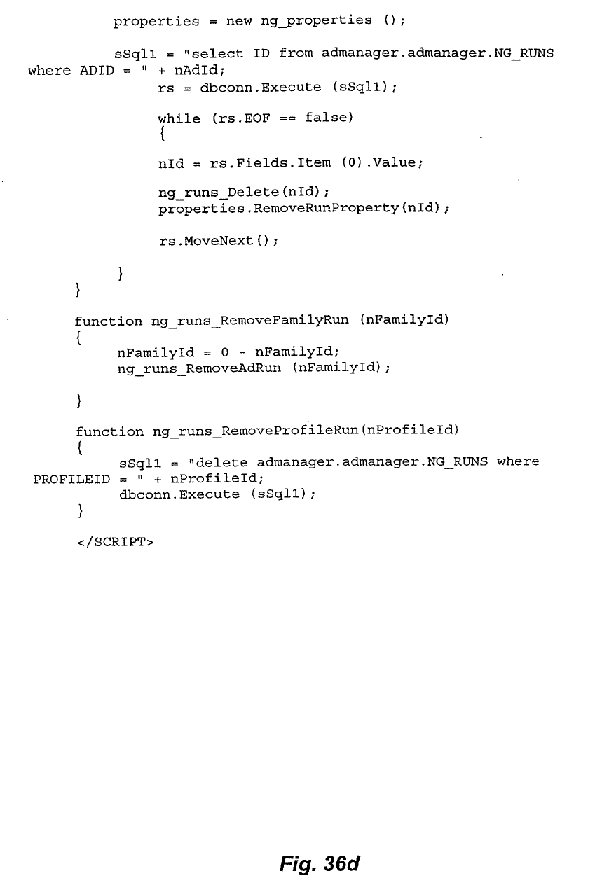

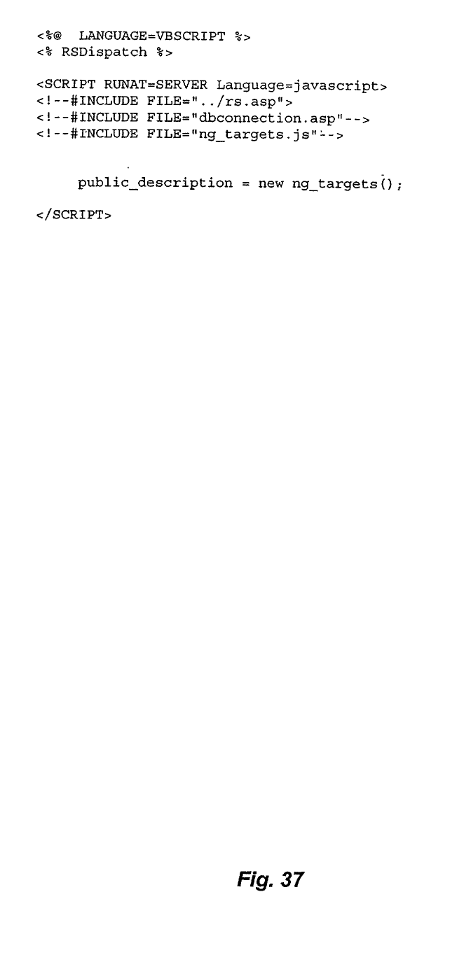

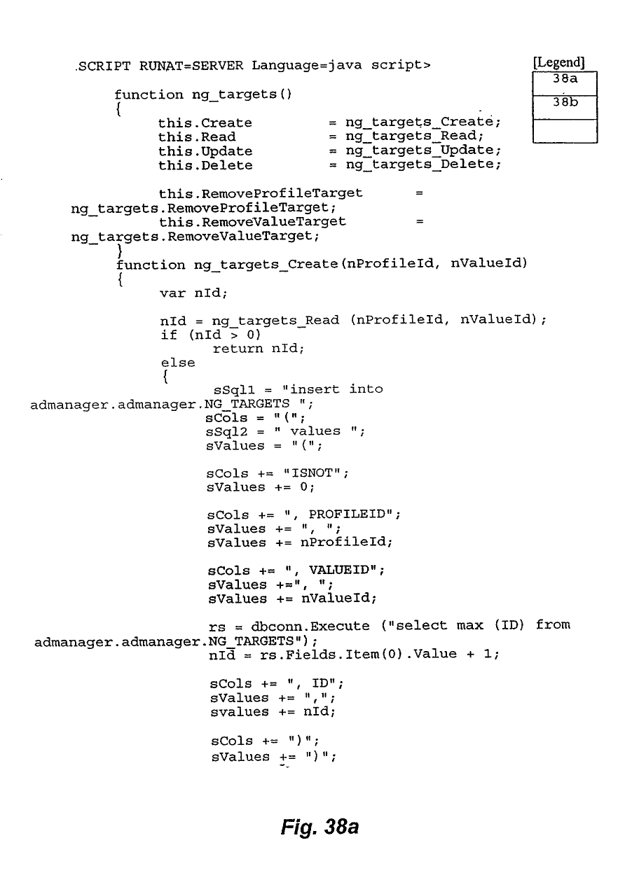

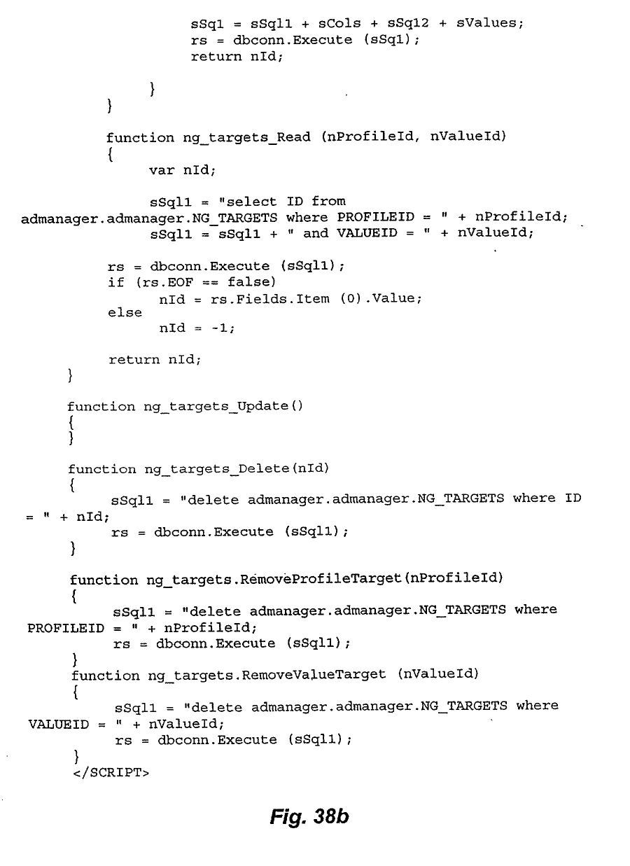

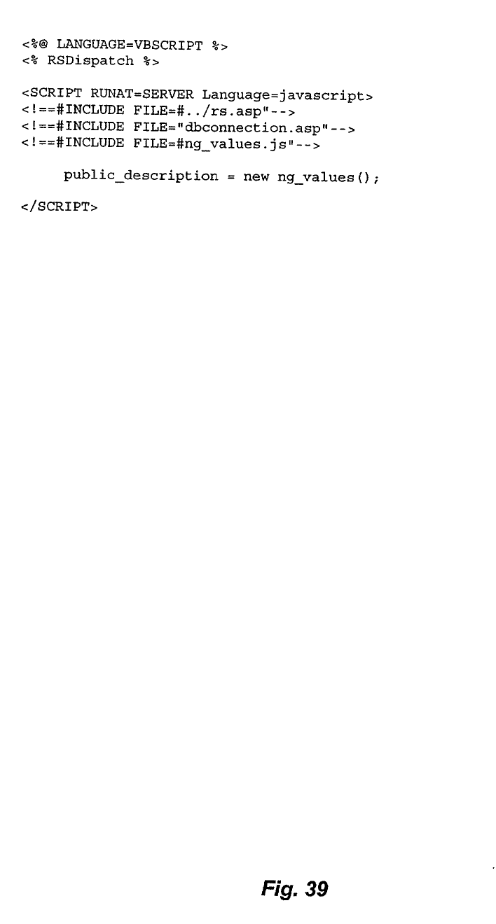

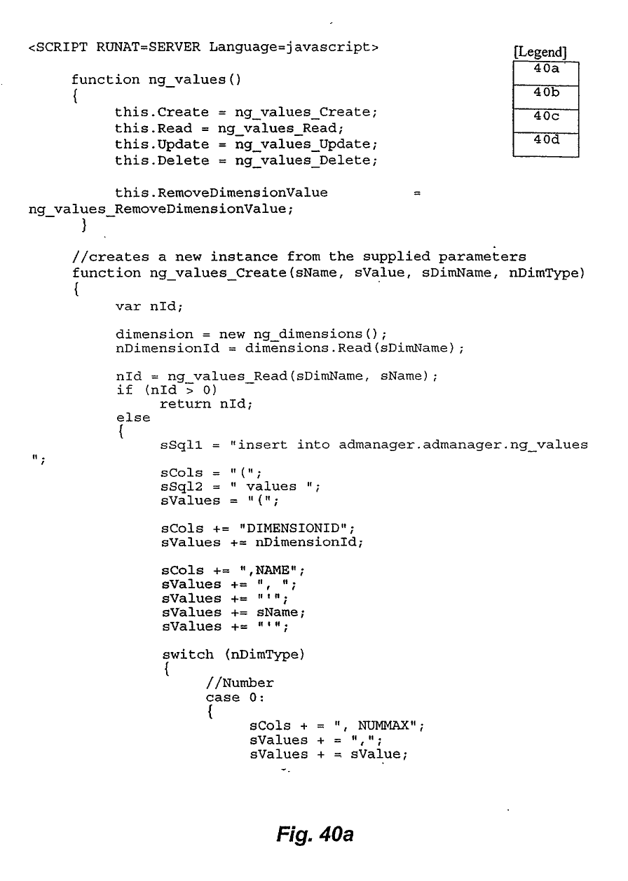

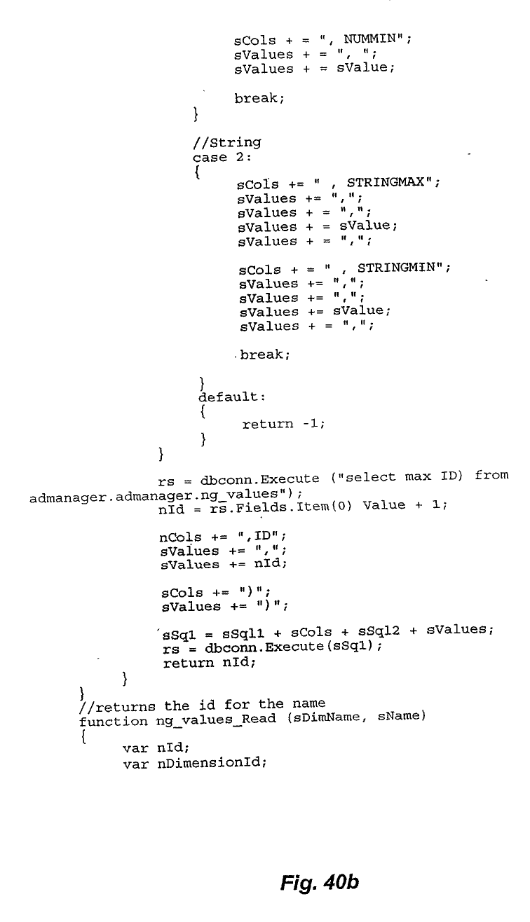

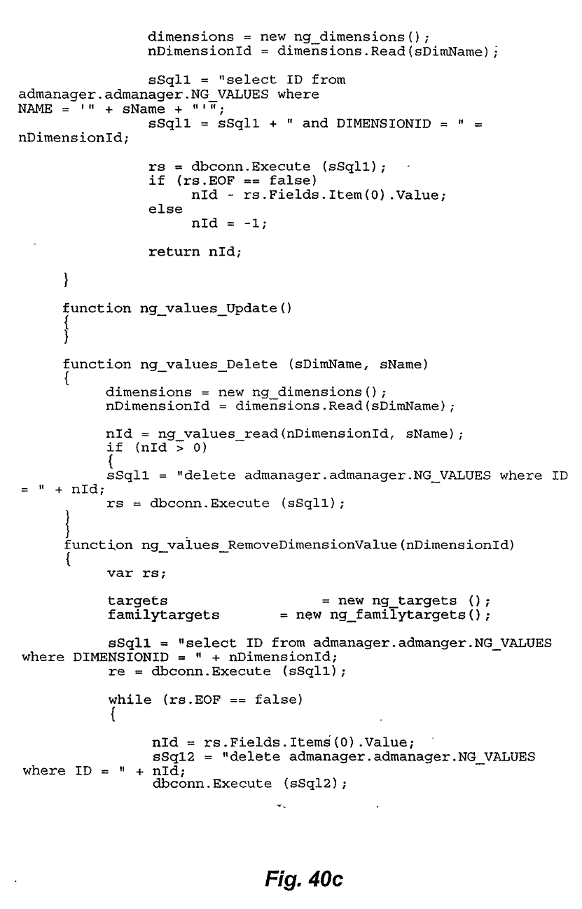

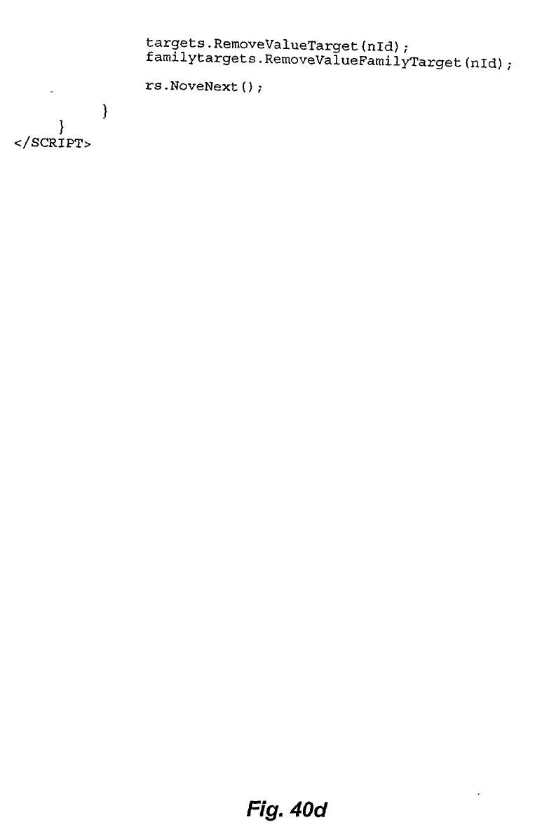

FIGS. 21-40 are listings of the software routines which embody the back-end tasks performed by API 44 in the foregoing implementation. These routines are referred to in the functional description provided in FIGS. 19a-19e. The following table correlates the figure numbers with these back-end routines:

| FIGURES | Routine |
|---|---|
| 21 | ng_ads.asp |
| 22a-22f | ng_ads.js |
| 23 | ng_advertisers.asp |
| 24a-24c | ng_advertisers.js |
| 25 | ng_dimensions.asp |
| 26a-26c | ng_dimensions.js |
| 27 | ng_families.asp |
| 28a-28b | ng_families.js |
| 29 | ng_familytargets.asp |
| 30a-30b | ng_familytargets.js |
| 31 | ng_profiles.asp |
| 32a-32d | ng_profiles.js |
| 33 | ng_properties.asp |
| 34a-34c | ng_properties.js |
| 35 | ng_runs.asp |
| 36a-36d | ng_runs.js |
| 37 | ng_targets.asp |
| 38a-38b | ng_targets.js |
| 39 | ng_values.asp |
| 40a-40d | ng_values.js |

It should be appreciated that there are many other embodiments, or variants of embodiments that are within the scope of the subject invention. For example, embodiments are possible in which links between elements are provided through means such as wireless communications links rather than the signal lines described in the foregoing embodiments. Thus, in FIGS. 1 and 5, any of the signal lines used to link the various elements together can be provided through wireless links. In addition, embodiments are possible in which the audio broadcasts and coordinated visual displays occur over communications networks other than the Internet such as, for example, local area networks, private or secure networks, or publicly available networks other than the Internet. In addition, embodiments are possible in which visual displays which are or include advertising material are coordinated with audio information that is not and does not include advertising material. For example, consider a situation in which it is desired to display a McDonald's visual advertisement during the time that a particular Metallica song is being played. The cut code for the song can be detected, and the visual display for the McDonald's advertisement displayed in accordance with the invention. In addition, embodiments are possible in which it is desired to coordinate a visual display that is not and does not include advertising material with an audio broadcast that is or includes an advertisement. Consider an example in which it is desired to display information about a Metallica album at the time that an audio broadcast of a McDonald's advertisement is occurring. The cut code for the McDonald's advertisement can be detected, and the image of the Metallica album displayed at about the same time that the advertisement is broadcast in accordance with the subject invention. Further, although the foregoing embodiments have been described in terms of coordinating visual information with a predetermined audio sequence or stream, it should be appreciated that embodiments are possible in which a first audio, visual, or audiovisual segment or stream is coordinated with a second predetermined audio, visual, or audiovisual segment or stream, including any and all combinations of the foregoing. One example that is expressly contemplated is supplementing “line” broadcasts with real time audio or visual coordinated information.

Accordingly, the invention is not to be restricted except in view of the appended claims and their equivalents.

1. A system for coordinating a visual display with an audio broadcast over a communications network comprising:
a client in the communications network for accessing a player configured to (1) receive over the communications network data representative of a plurality of audio segments; (2) detect and play an audio segment which includes advertising material; and (3) display generally concurrently with the playing of the segment an image related to the advertising material;
at least one server in the network accessible by the player and a first system executable on the at least one server configured to (1) maintain information related to the advertising material, including a schedule for the advertising material, and data representative of the image relating to the advertising material; and (2) manage display of the image consistently with the schedule for the advertising material; and
at least one interface between a second system, executable on one or more machines for managing broadcasts of audio advertisements, and the first system, the at least one interface executable on one or more machines for providing to the first system the information related to the advertising material derived at least in part from data maintained by the second system.

2. The system of claim 1 further comprising at least one broadcast server for broadcasting data over a communications network, the data representative of a plurality of audio segments.

3. The system of claim 1 in which the player is further configured to provide a user access to additional information relating to the advertising material responsive to the user clicking on the image.

4. The system of claim 3 in which the player is configured to obtain access to the additional information using a link stored on the at least one server.

5. The system of claim 1 in which the at least one interface comprises a first interface for interacting with a user, and a second interface for updating data maintained by the first system.

6. The system of claim 1 in which the player is configured to execute on the client.

7. The system of claim 1 in which the player is configured to execute on a server accessible by the client.

8. The system of claim 1 in which the at least one server includes a first server for maintaining a digital representation of the image related to the advertising material, and a second server on which the first system executes.

9. The system of claim 8 in which the at least one server includes a third server on which the at least one interface executes.

10. The system of claim 8 in which a link to the digital representation of the image is maintained on the second server.

11. The system of claim 9 in which the at least one server includes a fourth server for interfacing between the player and the second server.

12. The system of claim 3 in which the player is configured to obtain access to the additional information by spawning a browser.

13. The system of claim 12 in which the additional information is maintained on a server.

14. The system of claim 1 in which the communications network is the Internet.

15. The system of claim 1 in which the player is configured to coordinate the display of the image with the broadcast of the audio segment using an identifying code inserted within the segment.

16. A system for coordinating in a communications network a presentation of a first segment of material with a presentation of a second segment of material, a selected one of the first and second segments comprising or including advertising material, the system comprising:
a machine on which executes a player configured to (1) receive the first segment of material over the communications network; (2) present the first segment; (3) present the second segment generally concurrently with the presentation of the first segment;
at least one server in the network accessible by the player and a first system executable on the at least one server configured to (1) store information relating to the advertising material, including a schedule for the advertising material, and data representative of the second segment; and (2) manage the presentation of the selected one of the first and second segments consistently with the schedule for the advertising material; and
at least one interface between a second system, executable on one or more machines for managing broadcasts of advertisements, and the first system, the at least one interface executable on one or more machines for providing to the first system the information related to the advertising material derived at least in part from data maintained by the second system.

17. The system of claim 16 further comprising at least one broadcast server for broadcasting the first segment of material over a communications network.

18. The system of claim 16 in which the first segment is a segment from a group comprising audio material, visual material, and audiovisual material.

19. The system of claim 16 in which the second segment is a segment from a group comprising audio material, visual material, and audiovisual material.

20. A system for enabling coordination of a visual display with an audio broadcast over a communications network comprising:
at least one server in the network and a first system executable on the at least one server configured to (1) store information related to advertising material, including a schedule for the advertising material, and data representative of an image relating to the advertising material; and (2) manage display of the image in accordance with the schedule; and
at least one interface between a second system, executable on one or more machines for managing broadcasts of audio advertisements, and the first system, the at least one interface executable on one or more machines for providing to the first system the information related to the advertising material derived at least in part from data maintained by the second system.

21. A system for enabling coordination in a communications network between a presentation of a first segment of material and a presentation of a second segment of material, a selected one of the first and second segments comprising or including advertising material, the system comprising:
at least one server in the network and a first system executable on the at least one server configured to (1) store information related to the advertising material, including a schedule for the advertising material, and data representative of the second segment; and (2) manage presentation of the second segment in accordance with the schedule; and
at least one interface between a second system, executable on one or more machines for managing broadcasts of advertisements, and the first system, the at least one interface executable on one or more machines for providing to the first system the information related to the advertising material derived at least in part from data maintained by the second system.

22. A method for coordinating a visual display with an audio broadcast over a communications network comprising:
receiving over a communications network data representative of a plurality of audio segments;
playing an audio segment which includes advertising material;
displaying generally concurrently with the playing of the segment an image related to the advertising material;
displaying the image consistently with a schedule for the advertising material;
maintaining in a first system information related to the advertising material, including the schedule for the advertising material; and
providing to the first system the information related to the advertising material derived at least in part from data maintained by a second system for managing broadcasts of audio advertisements.

23. The method of claim 22 further comprising broadcasting the data representative of a plurality of audio segments over the communications network.

24. The method of claim 22 further comprising allowing a user access to additional information relating to the advertising material responsive to the user clicking on the image.

25. The system of claim 24 further comprising spawning a browser allowing the user access to the additional information.

26. The method of claim 22 in which the advertising material relates to a product or service, and the method further comprises allowing the user access to additional information about the product or service.

27. The method of claim 22 further comprising coordinating the display of the image with the broadcast of the audio segment using an identifying code inserted within the segment.

28. A method for coordinating in a communications network a presentation of a first segment of material with a presentation of a second segment of material, a selected one of the first and second segments comprising or including advertising material, the method comprising:
receiving the first segment of material over a communications network;
presenting the first segment;
presenting the second segment generally concurrently with the presentation of the first segment;
presenting the selected one of the first and second segments consistently with a schedule for the advertising material;
maintaining in a first system information related to the advertising material, including the schedule for the advertising material; and
providing to the first system the information related to the advertising material derived at least in part from data maintained by a second system for managing broadcasts of advertisements.

29. The method of claim 28 further comprising broadcasting the first segment of material over a communications network.

30. The method of claim 28 in which the step of presenting the first segment is from a group comprising playing audio material, displaying visual material, and concurrently playing and displaying audiovisual material.

31. The method of claim 28 in which the step of presenting the second segment is from a group comprising playing audio material, displaying visual material, and concurrently playing and displaying audiovisual material.

32. A method for enabling coordination of a visual display with an audio broadcast over a communications network, a selected one of the visual display and audio broadcast including or comprising advertising material, comprising:
maintaining, in a first system for managing displays of advertisements over a communications network, information related to the advertising material, including the schedule for the advertising material, and data representative of an image relating to the advertising material; and
providing to the first system the information related to the advertising material derived at least in part from data maintained by a second system for managing broadcasts of audio advertisements.

33. A method for enabling coordination in a communications network of a presentation of a first segment of material with a presentation of a second segment of material, a selected one of the first and second segments comprising or including advertising material, the system comprising:
maintaining, in a first system for managing presentations of advertisements over a communications network, information related to the advertising material, including a schedule for the advertising material, and data representative of the second segment; and
providing to the first system the information related to the advertising material derived at least in part from data maintained by a second system for managing broadcasts of advertisements.

34. Computer-readable media on which is stored a series of computer software instructions embodying a method for coordinating a visual display with an audio broadcast over a communications network, the method comprising the following steps:
receiving data over a communications network, the data representative of a plurality of audio segments;
playing an audio segment which includes advertising material;
displaying generally concurrently with the playing of the segment an image related to the advertising material;
displaying the image consistently with a schedule for the advertising material;
maintaining in a first system information related to the advertising material, including the schedule for the advertising material; and
providing to the first system the information related to the advertising material derived at least in part from data maintained by a second system for managing broadcasts of audio advertisements.

35. The media of claim 34 in which the method further comprises broadcasting over the communications network the data representative of a plurality of audio segments.

36. Computer readable media on which is stored a series of computer software instructions embodying a method for enabling coordination of a visual display with an audio broadcast over a communications network, the method comprising:
maintaining a first system for managing displays of advertisements over the communications network;
maintaining in the first system information related to advertising material, including the schedule for the advertising material, and data representative of an image relating to the advertising material; and
deriving the information related to the advertising material at least in part from data maintained by a second system for managing broadcasts of audio advertisements.

37. Computer readable media on which is stored a series of computer software instructions embodying a method for enabling coordination in a communications network of a presentation of a first segment of material with a presentation of a second segment of material, a selected one of the first and second segments comprising or including advertising material, the method comprising:
maintaining, in a first system for managing presentations of advertisements over the communications network, information related to the advertising material, including a schedule for the advertising material, and data representative of the second segment; and
providing to the first system the information related to the advertising material derived at least in part from data maintained by a second system for managing broadcasts of advertisements.

38. A system for coordinating in a communications network a presentation of a first segment of material with a presentation of a second segment of material, a selected one of the first and second segments comprising or including advertising material, the system comprising:
first means for (1) receiving the first segment of material over the communications network; (2) presenting the first segment; (3) presenting the second segment generally concurrently with the presentation of the first segment;
second means for (1) storing information relating to the advertising material, including a schedule for the advertising material, and data representative of the second segment; and (2) managing presentation of the selected one of the first and second segments consistently with a schedule for the advertising material; and
third means for providing to the first system the information related to the advertising material derived at least in part from data maintained by the second system.

39. The method of claim 28 further comprising presenting the first segment to a user.

40. The method of claim 39 further comprising presenting the second segment to the user generally concurrently with the presentation of the first segment.
